(19) United States
(12) Patent Application Publication
(10) Pub. No.: US 2004/0249745 A1
(43) Pub. Date: Dec. 9, 2004

(54) System and method for automatically adjudicating transactions involving an account reserved for qualified spending

(76) Inventor: Sharon A. Van Baaren, Westport, CT (US)

Correspondence Address: Dennis Smid, Esq., Frommer, Lawrence & Haug, 745 5th Avenue, New York, NY, 10151, US

(21) Appl. No.: 10/456,048

(22) Filed: Jun. 6, 2003

(51) Int. Cl. G06F 17/60

(52) U.S. Cl. 705/39; 705/42; 705/35

(57) ABSTRACT

A system and method for processing employee benefits plans is disclosed. A transaction made for purchasing products or services under employee benefits plan is automatically detected. For example, an electronic card may be used to make the purchase, wherein the transaction data is transmitted over a network. A participant is allowed to set up a pre-tax account as well as a post-tax account from which to fund the participant's spending expenses. By auditing the transaction and receipts associated with the transaction, a determination is made as to whether the transaction qualifies under the benefits plan and therefore, is an eligible transaction. If the transaction is not eligible for payment, a notification is sent to the participant to pay back the money. The money may be paid back using an online link provided.

### TECHNICAL FIELD

The present application relates to an automated system and method for processing benefits and more particularly to using electronic cards or similar electronic payment means for purchasing products and services under employee tax benefits plans.

The following definitions are used in the present application.

Dependent Care Reimbursement Account (“DCA”): an account allowable under section 125 of the United States Internal Revenue Service (IRS) code and other applicable codes that enables participants to pay for qualified purchases of dependent day care services on a pre-tax basis.

E-claim: an electronic claim that results from a card or electronic transaction.

EFA: an electronics funds adjudication system that enables plan service providers (“PSP”) to add electronic payment processing functionality to their existing manual claims processing system.

Flexible Spending Account (“FSA”): a flexible spending account program authorized by section 125 of the IRS code and allows a tax favored means of paying for qualified health care and dependent care expenses.

Health Care Reimbursement Account (“HCR”): an account allowable under section 125 of the IRS code that enables participants to pay for qualified healthcare expenses on a pre-tax basis.

Health Reimbursement Account (“HRA”): an account allowable under section 105 of the IRS code that enables companies to set aside post tax funds for their participants to pay for qualified healthcare expenses.

Merchant Category Code (“MCC”): a code that is assigned to the card processing interface between a merchant or business and payment processors such as Visa or MasterCard and defines the type of business they conduct. For example, an MCC of pharmacy is assigned to CVS/Pharmacy®; MCC of department store is assigned to Macy's Department Store.

Merchant Category Code Filtering: a means of blocking certain merchant category codes so that any related transactions at those merchants are declined.

Merchant Category Code Mapping: a means of enabling transactions to be approved at an MCC that has been incorrectly assigned once verification is received that the merchant is a qualified provider.

Merchant Category Code Override: a means of enabling transactions to be approved at an MCC that has been incorrectly assigned once verification is received that the products or services are qualified.

Parking Reimbursement Account (PKG): an account allowable under section 132 of the IRS code that enables participants to pay for qualified commuter parking expenses on a pre-tax basis.

Post Dependent Care Account (PTD): is an account that enables participants to pay for commuter transit expenses on a post-tax basis.

Post Tax Transit Account (PTT): is an account that enables participants to pay for commuter transit expenses on a post-tax basis.

Post Tax Parking Account (PTP): is an account that enables participants to pay for commuter parking expenses on a post-tax basis.

Participants: employees of companies (and any applicable dependents) that elect to participate in the programs Plan Service Provider (“PSP”): a company that administers and processes claims for flexible spending accounts and transportation reimbursement plans on behalf of employers.

Transaction Service Provider (“TSP”): a company that provides an interface between banks and electronic payment networks such as MasterCard and Visa for processing of electronic payment transactions.

Transportation Reimbursement Account (“TRN”): an account allowable under section 132 of the IRS code that enables participants to pay for qualified commuter transit expenses on a pre-tax basis.

### BACKGROUND

The United States Internal Revenue Service (“IRS”) code sections allow a participant and eligible dependents to save a considerable amount of money in taxes through Flexible Spending Accounts (“FSA”) and Transportation Reimbursement Accounts. Particularly, the program allows Participants to deduct a predetermined amount of money from the participant's before-tax income. This predetermined amount of money is set-aside in the participant's account, which is sometimes referred to as a flexible spending account or a flex account. The money then can be used toward paying for expenses incurred for certain eligible products and services specified by the IRS. Because the money is deducted from the employee's before-tax income through payroll deductions, the amount of tax that is actually paid by the employee is reduced. Further, the employer's FICA payment is reduced based on the applicable amount of pre-tax contributions made by their employees.

The eligible expenses include health care, dependent care, transit/van pool, and parking expenses. The pre-tax deductions from the payroll are set-aside in spending accounts, which are divided into sub-accounts. The sub-accounts include health care reimbursement accounts (“HCR”), dependent care reimbursement accounts (“DCA”), transit/van pool reimbursement accounts (“TRN”) and parking reimbursement accounts (“PKG”). The accounting of the funds set aside through payroll deduction into these four sub-accounts is separate, and the accounts may not be commingled. For example, the money in the transit/van pool account may only be used to pay for the transit/van pool (“TRN”) expenses, and may not be used for parking (“PKG”), HCR, or DCA expenses.

Further, each category of accounts has separate rules that must be complied with when obtaining the reimbursement. For example, in an HCR account, which provides pre-tax dollars to pay for healthcare related products or services, Plan Service Providers (“PSP”) are required to provide projected annual contributions per participant. Each participant may not spend more than the projected annual contribution, but may claim the entire projected amount with initial use or at any time during the plan year. For example, if a participant's annual contribution is $1,200, to be deducted at a rate of $100 per month from the participant's paycheck, the participant may spend the entire annual contribution amount, that is, $1,200 anytime during the plan year even if all 12 of the employee's payroll deductions did not yet occur. The projected amount may differ from employer to employer. The funds may be lost if a participant does not use the entire amount during the plan year.

The DCA account provides pre-tax dollars to pay for dependent day care expenses. The DCA account funds may also be lost if the participant does not use the funds during the plan year. With DCA accounts, a participant may spend only up to the amount that has been actually deducted from the payroll.

The transit/van pool account (“TRN”)is funded with deductions per pay period and cannot exceed the monthly maximum approved by the IRS. For example, as of year 2003, the maximum monthly allowable contribution into this account is $100. The monthly maximum is periodically reviewed and may be revised by the IRS. The balance of the account carries forward from month to month provided that the monthly maximum is not exceeded.

The parking account (“PKG”) is also funded with deductions per pay period and cannot exceed the monthly maximum approved by the IRS. For example, as of year 2003, the maximum monthly allowable contribution to this account is $190. The monthly maximum is periodically reviewed and may be revised by the IRS. The balance of the account carries forward from month to month provided that the monthly maximum is not exceeded.

The United States Internal Revenue Service (“IRS”) code sections allow a plan sponsor or company to set aside money on a post tax basis for their participants or employees. The money can then be used toward paying for healthcare expenses incurred for certain eligible products and services specified by the IRS. These post-tax deductions or contributions are set-aside in a separate account called an “HRA” account and this account cannot be co-mingled with any other accounts such as health care reimbursement accounts (“HCR”), dependent care reimbursement accounts (“DCA”), transit/van pool reimbursement accounts (“TRN”) and parking reimbursement accounts (“PKG”). Further, each category of accounts has separate rules that must be complied with when obtaining the reimbursement. For example, in an HRA account, which provides post-tax dollars to pay for healthcare related products or services, Plan Service Providers (“PSP”) may provide projected annual contributions per participant whereby each participant may not spend more than the projected annual contribution, but may claim the entire projected amount with initial use or at any time during the plan year. For example, if a participant's annual contribution is $1,200, to be deducted at a rate of $100 per month from the participant's paycheck, the participant may spend the entire annual contribution amount, that is, $1,200 anytime during the plan year even if all 12 of the employee's payroll deductions did not yet occur. The projected amount may differ from employer to employer. Another option allows the plan sponsor to limit spending to the actual amount of the contributions provided at a predetermined frequency such as monthly. The funds may be rolled over for use in future years either in full or up to an amount determined by the plan sponsor if a participant does not use the entire amount during the plan year.

Once the above accounts are set up, a participant has traditionally claimed the money in the accounts by first incurring the eligible expenses, paying for the expenses out of the participant's own funds, filling out appropriate forms manually, and sending the forms with receipts for the expenses incurred to the PSP that is contracted with their employer to administer the program. The PSP then reviews the incurred expenses and if they qualify as one of the eligible expenses under the IRS regulations, the PSP sends a check to the participant or uses direct deposit or other reimbursement method, and deducts the amount from the participant's set-aside accounts. This process is shown in FIG. 1.

FIG. 1 shows a flow diagram illustrating a traditional method for claiming reimbursement for qualified expenses using a manual claims administration program. At 102, an employee makes an election to participate in the spending account plan sponsored by their employer. At 104, payroll deductions in an allocated amount specified by the employee and not exceeding the allowable maximum, are made before any applicable taxes, such as federal, state, and local, are applied. The deductions are saved into appropriate accounts, for example, HCR, DCA, TRN, PKG, HRA sub-accounts. At 106, the employee seeks services or purchases products. At 108, the employee pays the provider of the services for purchases of products or services with the employee's own after-tax money. At 110, the employee fills out a form for reimbursement and sends the form with receipts to a PSP.

At 112, the Plan Service Provider (“PSP”) reviews the claim for reimbursement, that is, the form with the receipts for products or services purchased and paid for. The PSP determines from the receipt, for example, whether the service or purchased item qualifies for reimbursement. The PSP also determines whether this participant's appropriate sub-account has enough available funds to pay for the expenses. At 114, the PSP approves or denies the claim for reimbursement based on the eligibility and amount of funds available in the sub-account. For example, if the receipt lists a purchase item of toothpaste purchased at a drug store, the item would not qualify for reimbursement. On the other hand, if the receipt lists prescription eyeglasses, the item would qualify for the HCR account. In this case, if the sub-account shows enough funds, the PSP would reimburse the participant. At 116, the PSP sends a check, direct deposit or other reimbursement methods to reimburse the participant, if approved. Alternatively, the PSP sends a denial letter or e-mail, if rejected, to the participant. At 118, the participant receives the reimbursement. At 120, the participant deposits or cashes the reimbursement check.

In this traditional method of manual claims administration, a participant always has to first pay for the expenses out of the participants' own funds, then fill out appropriate forms and send in receipts in order to receive reimbursements. To avoid initial out-of-pocket expenses and the many inconveniences associated with filing manual claims to receive reimbursements, an electronic payment system can be used that directly and electronically takes out the amount of payment from the employee's appropriate sub-account, when the employee uses the card or similar payment means to pay for the product or service. In this way, the employee need not first pay out of his/her own funds when using the services or purchasing products, which qualify for reimbursement under the plan.

For example, an electronic payment process using a card similar to a debit, credit or stored value card that electronically accesses funds available in the participants' accounts are provided to the participants. When the participant uses the card, the amount of money is automatically transferred from the participants account to the merchant's bank account via an established payment-processing network such as VISA or MasterCard. Using the cards reduces the paper work involved for the participant, the employer and the PSP. Moreover, the participant does not need to pay for the products or services upfront with the participant's own funds.

One drawback associated with these existing electronic card systems is that they do not check whether the products or services purchased with the cards are qualified expenses under the benefits plan. That is, even if the purchases were made from an eligible merchant, not all products or services purchased may be qualified expenses based on IRS regulations. For example, pharmacies sell prescription drugs that qualify for reimbursement under the flexible spending account program, as well as products that do not qualify under the plan. Such non-qualifying products include shampoo, toothpaste, candy, and other similar items. The existing card systems currently allow a participant to purchase products or services with the card as long as the purchase is made from a qualified merchant. These systems, however, do not review or check whether the individual products or services purchased qualify under IRS regulations.

Using the accounts for ineligible products or services means that the employee and the employer are not fully complying with regulations set forth by the IRS. These non-qualifying uses may forfeit the company's as well as the employee's access to such programs, resulting in a great amount of loss such as loss of tax savings, and may result in the employer and the employee being penalized for not complying with the IRS codes.

Moreover, for this reason, many companies are reluctant to use the currently available electronic card systems even though they may result in a great deal of convenience and tax savings. Therefore, there is a need to have an electronic card system that automatically monitors and adjudicates such electronic claims made with a card or similar payment means to ensure that the employees or the participants are using the cards or similar payment means for only those products and services, which do qualify under applicable IRS regulations.

### SUMMARY

A method and system disclosed in the present application in one aspect processes transactions, for example, made using electronic cards or similar payment means for purchasing products and services under the benefits plan such that the payment is made directly from a reserved benefit account rather than from the purchaser's own funds. The method and system adjudicates each transaction so that each transaction is in compliance with IRS regulations. In one aspect, the method of the present disclosure automatically detects and records an electronic claim (“e-claim”) made by a participant. For example, when transaction data associated with a purchase using an electronic card is received, determination is made as to whether the purchase is a qualified transaction, and if it is determined that the purchase is not a qualified transaction, a refund is requested from the participant.

In one aspect, a request for a receipt associated with the purchase is sent until a receipt is received. In another aspect, a receipt received for the e-claim is used to audit the e-claim to determine whether the e-claim is a qualified transaction, that is, an eligible claim.

If the e-claim is not an eligible e-claim, a number of actions may be automatically triggered. Such actions include sending a letter or e-mail or similar communication means to the participant informing the person that a payment for a claim that is not eligible under the benefits plan has been made. The notification also requests a repayment of the ineligible claimed amount back to the participant's account. If the repayment is not made, for example, within a predetermined amount of time, the participant's card may be automatically deactivated so that the participant is prohibited from using their card for any future transactions.

In one embodiment, if the participant pays back the amount after the participant's card was deactivated, the participant's card may be reactivated. In another embodiment, the notification may be an electronic “e-mail”, and may also include a hyperlink through which the participant may make an electronic payment to pay back the money that was used for purchasing the ineligible product or service.

If the e-claim is determined to be eligible, the e-claim is approved, and an appropriate code is assigned. These codes may be used to audit various data concerning the participant's claim activities and/or generate various history reports.

In another aspect, the method includes providing a post-tax account from which an amount of money for the purchase may be deducted if a pre-tax account does not have a sufficient amount for the purchase. The post-tax account may include an amount deducted from a paycheck after taxes have been paid, an amount approved on a charge card or an amount contributed by the participant's employer and can be for healthcare, transit, parking, HRA, dependent care, etc. For example, if the participant's monthly train ticket is $200 ($100 in excess of the current IRS monthly maximum of $100), the participant may contribute the remaining $100 with after tax or post-tax contributions. This enables the participants to use their card or similar payment means for monthly transit or parking expenses that are greater than the IRS maximums. Without this functionality, the participant would need to pay for the $100 amount, using the card and pay for the $100 balance using another payment means. The participant may be forced to pay the expenses in full with their own funds and submit a manual claim to receive reimbursement. Pre-tax contributions may be used prior to post-tax contributions or vice versa depending on the plan provisions.

In one embodiment, the e-claim data is received in real time, such that claims made by a participant is reviewed, and processed as soon as the claim is made. In another embodiment, the e-claim data may be batch data, for example, a day's worth of e-claim data downloaded from an electronic payment processors database.

Yet in another embodiment, a purchase is automatically determined to be a qualified transaction if a merchant code from which the purchase is made matches a predetermined automatic adjudication merchant code and an amount of the purchase matches a predetermined automatic adjudication amount.

Further features and advantages as well as the structure and operation of various embodiments of the present invention are described in detail below with reference to the accompanying drawings. In the drawings, like reference numbers indicate identical or functionally similar elements.

### BRIEF DESCRIPTION OF THE DRAWINGS

FIG. 1 shows a flow diagram illustrating a traditional method for claiming reimbursement for the flexible spending and transportation expenses.

FIG. 2 is a flow diagram that illustrates the use of the electronic card or similar payment means by a participant in one embodiment of the present invention.

FIG. 3 is a flow diagram illustrating the processing of the e-claims in one embodiment of the present invention.

FIG. 4 is a flow diagram illustrating the adjudication process in one embodiment of the present invention.

FIG. 5 is a flow diagram that illustrates a detailed e-claim adjudication process in one embodiment of the present invention.

FIG. 6 is a diagram that illustrates the integration of the e-claims with the manual claims in one embodiment of the present invention.

FIG. 7 is a flow diagram illustrating card administration in one embodiment of the invention.

FIG. 8 is a flow diagram illustrating the spending transaction approval process in one embodiment.

FIG. 9 is a flow diagram illustrating the pay back process using a website in one embodiment.

FIG. 10 is a block diagram illustrating the blocking, unblocking, and/or closing of a card in one embodiment.

FIG. 11 shows an example of an override process.

FIG. 12 is a flow diagram illustrating an example of auto-adjudication process in one embodiment.

FIG. 13 is a flow diagram illustrating another example of auto-adjudication in one embodiment.

FIGS. 14A and 14B is a flow diagram illustrating an overview of the electronic card transaction in one embodiment.

FIG. 15A is a flow diagram illustrating participant enrollment data file transfer process in one embodiment.

FIG. 15B is a flow diagram illustrating participant card funding file transfer process in one embodiment.

FIG. 15C is a flow diagram illustrating data file transfer process in one embodiment in a manual claim processing.

FIG. 16 is a block diagram illustrating system interfaces in one embodiment.

FIG. 17 is a flow diagram illustrating a pay back method in one embodiment.

FIG. 18 is a flow diagram illustrating a random audit process.

FIG. 19 illustrates an example of pre and post tax processing in one embodiment.

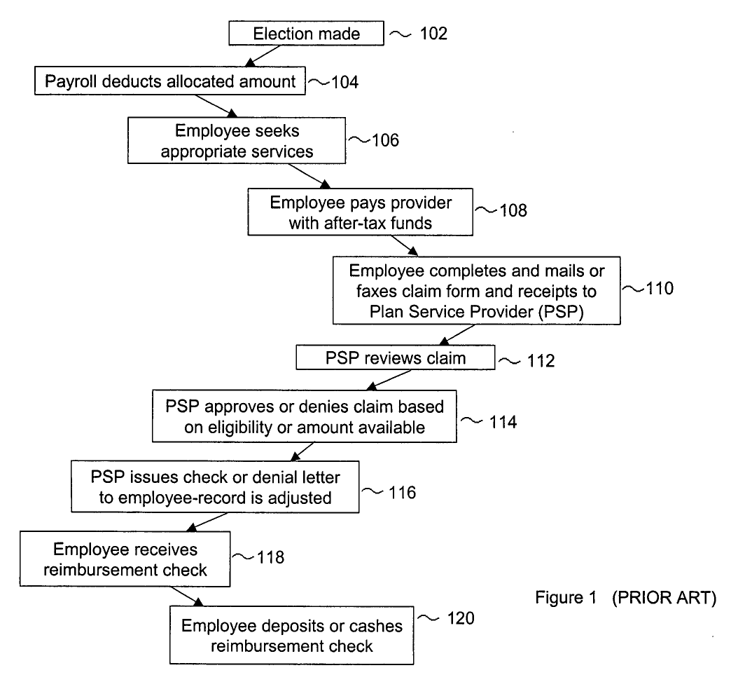

### DETAILED DESCRIPTION

The present application discloses an electronic flex card administration system (“EFA”) that processes employee-spending accounts such as the flexible spending accounts, transportation reimbursement and HRA accounts electronically in real time. The system and method of the present application provides a card similar to a debit, stored value, credit card or similar payment means, referred to as a flex card, to a participant and any applicable dependents. Participants may then use the card in a similar manner as a debit, stored value, credit card or similar payment means.

Transactions that are made through the flex card are referred to as electronic claims (“e-claim(s)”). These transactions or e-claims are processed and reviewed to determine whether they contain valid claims. A determination is also made to ensure that there are sufficient funds available in this participant's accounts. This method allows the participant to pay for the eligible healthcare, dependent care, transit and parking expenses directly from his set-aside account without having to wait for reimbursement and without going through a lot of paper work.

For example, when an employee decides to participate or enroll in the flexible spending or transportation benefits plans, the participant, automatically receives the card. The participant then signs the card before using it. By signing, the participant agrees to the terms of the card administration system such as acknowledging that the funds are authorized only for the payment of qualified expenses, certifying that the funds have not been and will not be reimbursed under any other plan coverage, and agreeing that the participant will submit any required documentation to the PSP.

As soon as the participant's account is set up with the employer for eligible expenses and the payroll deductions or employer contributions begin, the participant may begin using the card. The card works the following way. The participant purchases products or services that are qualified expenses under the flexible spending account, transportation and HRA program. To pay for the products or services, the participant uses the card like any other debit, stored value or credit card. The participant then sends the receipts to the PSP contracted by their employer.

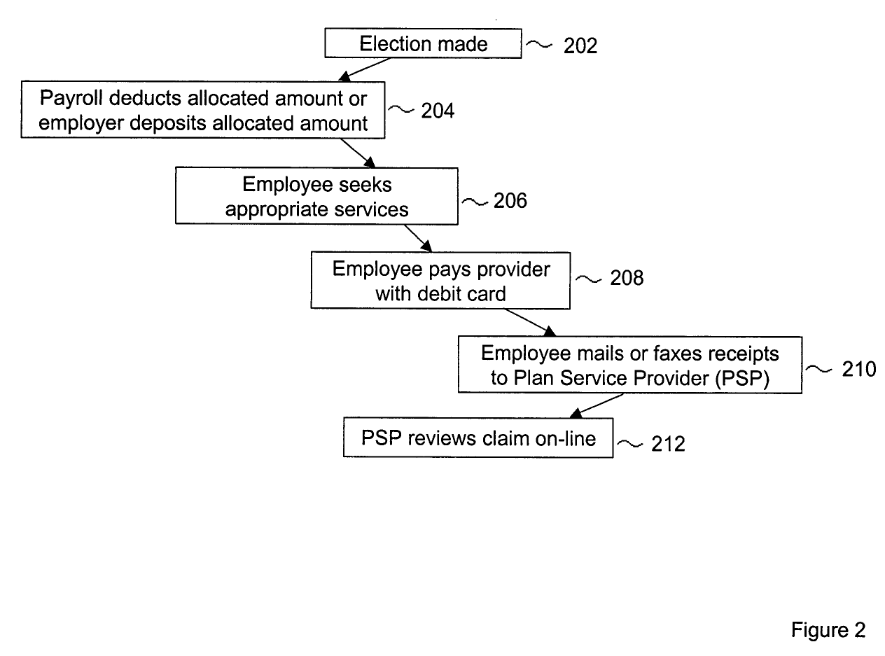

FIG. 2 is a flow diagram that illustrates the use of the card by a participant in one embodiment of the present invention. At 202, an employee makes an election to participate in the flexible benefits, transportation and HRA plans. The employee is referred to as a participant. At 204, an amount specified by the participant is deducted from the participant's payroll and/or an amount is contributed by the employer and is set-aside into the participant's account. At 206, the employee seeks appropriate services, for example, purchases prescription eyeglasses, or incurs commuter-parking fees. At 208, the employee pays the provider for the expenses incurred with the card issued to the participant. At this point, a transaction or an e-claim has occurred. At 210, the participant sends in by mail, e-mail, fax, etc., the receipt that itemizes the expenses incurred. At 212, the PSP uses the EFA system to review the expenses on-line by auditing the transaction or the e-claim. The EFA review includes the adjudication process, which will be described in more detail below.

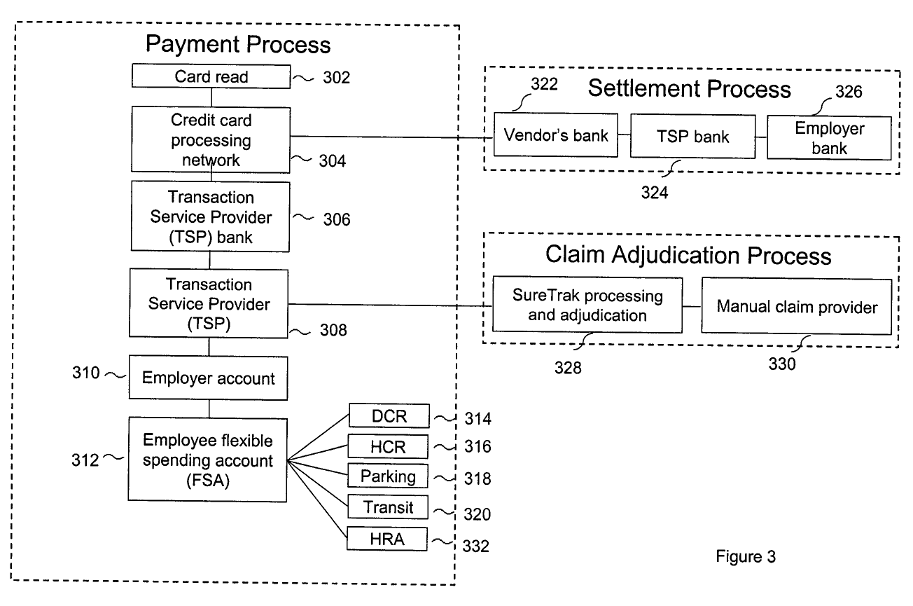

FIG. 3 is a flow diagram illustrating the processing of the e-claims in one embodiment of the present invention. At 302, a participant uses the card by, for example, swiping the card when making a purchase at an eligible merchant. An eligible merchant, for example, may be a doctor's office, an eyeglass center, a parking lot, or a pharmacy. In one embodiment, the card is provided by a transaction service provider (“TSP”) who has agreements with banks and credit, debit or stored value card processing companies. A TSP may also be referred to by banks as a payment processor. At 304, a debit, stored value or credit card processing network is notified of a card transaction. At 306, the bank that has agreed to process the card is also notified. At 308, the transaction performed with the card is then transmitted to a TSP. At 308, the TSP pre-authorizes the transaction by checking the card's status and the account balance associated with the appropriate sub-accounts 314, 316, 318, 320, 332 of the card for that merchant category code (“MCC”) to determine if the merchant is qualified at 310 and 312. At 308, if the MCC and the amount are approved, then the transaction or e-claim is pre-authorized. If the transaction is pre-authorized, at 310, a hold is put on the money at the TSP. If not pre-authorized, then the transaction is declined. In one embodiment, the EFA system receives the pre-authorization notification from the TSP.

The EFA system, of the present disclosure, may receive one or more types of transactions for EFA processing. The transaction types may include pre-authorizations also referred to as holds, forced-posts, settlements, refunds, and manual transactions. The following information is typically supplied to process the transactions: account balance, account number, account type, approval code, card number, effective date, MCC, merchant ID, merchant type, message type, original transaction date, original settlement date, pending hold balance, start date, end date, pre-auth hold balance, transaction amount, transaction status, transaction type, transaction code, terminal city, terminal state, TSP identifier, TSP settlement number, TSP settlement date.

As described above, a pre-authorization transaction is a transaction that is sent by a merchant to authorize the transaction and at which time the pre-authorization amount is placed on hold. Pre-authorizations or holds are not settled. Forced-post transactions are transactions submitted to force a posting where no previous pre-authorization or hold was supplied.

A settlement occurs when a transaction is completed and the pre-authorization or hold is replaced with the settled transaction. Forced-posts are settled as posted. As a consequence of settlement, account funds are deducted from the account balance.

For pre-authorization transactions that the EFA system has not received a matching settlement transaction after 30 days, the pre-authorization or hold is released. If a pre-authorized amount is released, that amount is placed back into the participant's account.

Other transaction types may include purchases (typically pre-authorized), refunds, and returns. Purchase transactions are the transactions submitted to both request and validate a purchase. Purchases may be declined or purchases may be settled. Account funds are deducted from the participant's account balance. Refund transactions are the transactions submitted to request a refund of previous purchases or forced-post. Refunds may be declined or refunds may be settled. These funds are then credited to the participant's account balance.

Returns may be made for products purchased. These transactions are associated back to the original transaction by a transaction identifier. Should participants return products to a merchant, the transaction credits back to the participants' account from which it was taken. The transaction details are then reported back to the PSP via, for example, an XML document. The transaction details may include: transaction identifier, account type, card number, administrative fee, transaction date, MCC, merchant name, response code, settlement date, transaction amount, transaction code, and transaction status.

When a participant is notified to reimburse their account, for example, because the item purchased with the card is not an eligible flex spending, transportation or HRA expense, the participant may do so by logging on a website and paying by personal credit card. The participant may also mail in a check or wire the ineligible spending reimbursement funds to the PSP. The EFA system of the present disclosure generates an XML or batch document when payments are made and supplied to the PSP. To process the refunds, the following information may be supplied to the EFA system in one embodiment: original transaction identifier, original transaction settle date, return/credit amount, participant or employee identification number, transaction identifier, transaction code, transaction fee amount, account type, and transaction type.

Referring back to FIG. 3, if the transaction is pre-authorized, the processing continues to the settlement process. At 322, the merchant's bank requests a payment. At 326, the employer or the card sponsors having access to the sponsoring bank account is notified that the amount of money is needed for settlement to be made typically within 24-48 hours. The employer may be notified by the EFA system, which processed the pre-authorization and forced-post transactions. The employer provides funds or makes funds available to the PSP for settlement. At 322, the merchant receives payments for services provided or products purchased. At 328, the processing continues to the EFA system where the e-claims are adjudicated. At 330, a PSP that is processing manual claims (a transaction where the card is not used) notifies the EFA system of any manual claim payments that have been made. This way, the EFA system keeps track of both e-claims and manual claims in order to adjust balances and keep them current.

A settlement occurs when the transaction is to be paid by the employer's bank 326. This usually takes between 24 and 48 hours. Settlement occurs when force-post and purchase (pre-authorization) transactions are sent by the processing bank 324 for settlement to the plan sponsor bank 326. These transactions have been received by the EFA system. The funds are deducted from the plan sponsor or PSP account to fund the transaction amount. If a refund transaction has occurred, these transaction amounts are credited to the plan sponsor or PSP account 326.

Following a forced-post or pre-authorization, a request for funds is generated by the EFA system. This request for funds may be e-mailed to the PSP or plan sponsor on such timetable as established, which may include each morning for the prior 24-hour period totals. The request for funds may include: transaction date, employee identification number, first name, last name, fee, amount, number of transactions, number of manual transactions, total purchase amount, total fees, and total.

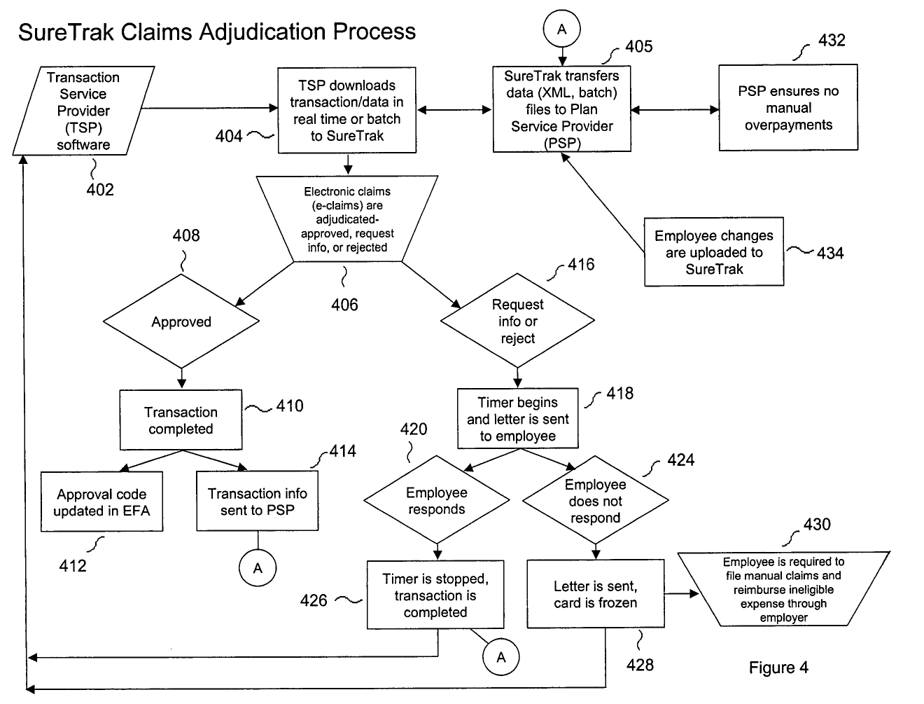

FIG. 4 is a flow diagram illustrating the e-claim adjudication process in one embodiment of the present invention. At 404, e-claim data is downloaded from the transaction service provider 402. The data may be downloaded in real time, that is, when the transaction occurs. For example, at 405, the real time data may be transferred in an extensible markup language (“XML”) format. The data may also be downloaded in a batch mode, for example, a day's worth of data at the end of the day. From the e-claim data received, the EFA system may detect an occurrence of transaction for an e-claim. The EFA system also may detect an e-claim when a receipt of a transaction is received without a matching e-claim. In this case, the EFA system monitors any incoming e-claim data to match to the receipt.

At 406, the e-claim is adjudicated, for example, by approving, requesting more information, or rejecting the e-claim. To approve the e-claim, it is determined, for example, by comparing the receipt, whether the e-claim was used for one of the eligible products or services. If the e-claim was used for an eligible product or service, at 408, the e-claim is approved. At 410, the transaction is completed, and at 412, an appropriate approval code is updated in EFA and sent to the plan service provider. At 414, the transaction information is also sent to the PSP. The PSP, for example, processes the flexible benefit and transportation claims that are filed manually. In this way, both e-claim and manual claims are integrated at both the EFA system-and the PSP to provide an-up-to-date account balance associated with a participant and up-to-date transaction information associated with this participant.

At 416, the EFA system determines whether a receipt that matches this transaction has been received. If not, a request for the receipt is automatically sent to the participant for the request. The request may be made via e-mail, a letter, or any other means. The EFA system may trigger an automatic sending of the request for the receipt periodically until the receipt is received or for a predetermined number of times. In the case that the participant does not send in the receipt, the e-claim may be adjudicated as rejected.

At 416, the EFA system may reject the e-claim if the receipt shows ineligible products or services purchased. Further, if more detailed information is required, for example, because the receipt does not distinguish the products purchased or the service rendered, a request for information is sent to the participant at 418. At the time the request is sent, a timer may be set to begin counting the time within which the participant needs to respond. At 420, if the employee responds within a predetermined amount of time, and if it is determined that all the products purchased or services provided in the transaction are qualified expenses, at 426, the timer stops, an appropriate approval code is set, and the transaction is completed.

At 424, if the participant does not respond, at 428, a notification letter or e-mail is sent to the participant, and the card is deactivated. When the card is deactivated, the participant may no longer use the card to purchase products or services. Instead, the participant is required to file for the benefits claims manually as well as repaying the e-claim ineligible expense.

Similarly, for e-claims that are rejected, the participant is sent a notification that the e-claim is not valid, and the participant must-pay back the amount of money deducted from the participant's flex benefit account to pay for the e-claim expense. If a substantiated claim is subsequently received, the funds approved from that claim can be used to offset the ineligible expenses. In one embodiment, if the participant does not pay the money back and it cannot be offset by another claim, the card is deactivated automatically. Further, the participant's employer may be notified along with additional information so that the employer may take its own actions in recovering the amount of payment, e.g., by automatically deducting the amount from the participant's paycheck.

In the notification sent to the participant, the EFA system may provide an automated way for the participant to pay back the amount. For example, if the notification is sent by e-mail, the e-mail may include a hyperlink to a web site that accepts credit card payments. The participant may then pay back by using the participant's personal credit or debit card.

At 432, all manual payments made by a PSP are sent to the EFA system so that the EFA system can keep track of the up-to-date information and accurate account balances. At 434, changes in employee or participant data are also sent to the EFA system for the most updated information to be kept by the EFA system.

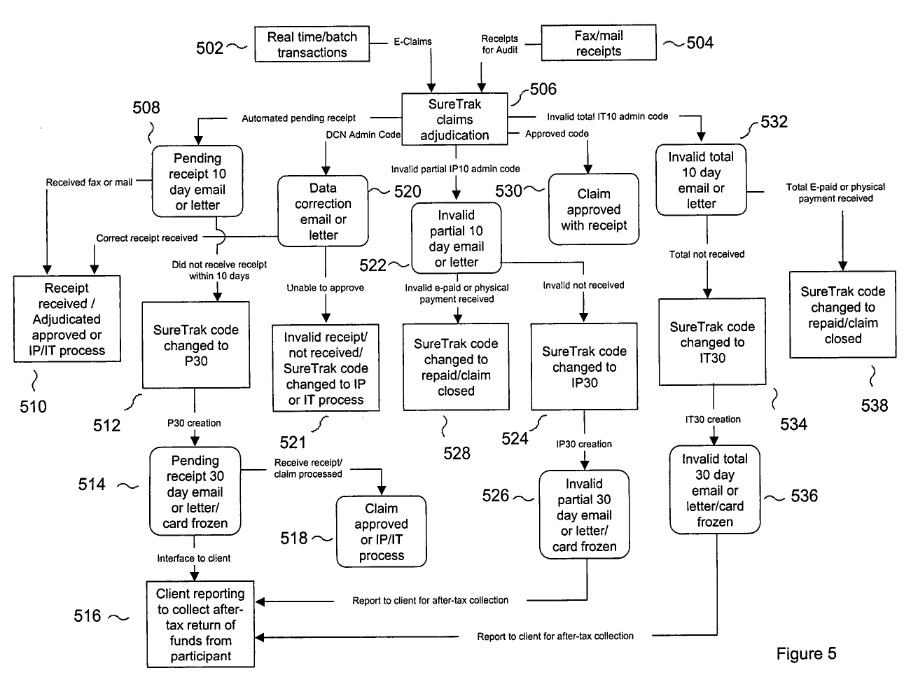

FIG. 5 is a flow diagram illustrating a detailed e-claim adjudication process in one embodiment of the present invention. At 502, e-claim data, that is, transaction data is received either in batch mode or in real time from the TSP. At 504, receipts used for the e-claim transactions are received. The receipts may be received by any method, for example, e-mail, facsimile, and mail. The receipts include transaction details for the products or services purchased by the participant. At 506, the EFA system adjudication process begins. The EFA system assigns appropriate administration (“admin”) codes to each transaction. For example, The EFA system generates participant transaction status letters or e-mails automatically at a predetermined time period, for example, 10 and 30 days after the occurrence of a transaction (e-claim), if electronic adjudication has not occurred because the participant did not send in the required receipts. The predetermined time period may be any number of days and may be decided by a plan service provider (PSP).

At 508, if an e-claim occurred 10 days ago and if the EFA system did not receive a receipt for the e-claim, a P10 code is assigned to the e-claim. The P10 code automatically triggers contacting the participant. For example, a 10-day pending letter or e-mail may be generated and sent. At 510, if the participant sends the receipt, the process continues to either approve or deny the e-claim.

At 512, if 30 days have passed since the e-claim was detected, and if the participant still did not send the receipt, the code is changed to P30. P30 code automatically triggers sending out 30 day pending notification to the participant at 514. At the same time, the card may be deactivated such that the participant may no longer use the card. At 516, the EFA system also may notify the employer of the participant's status and the participant's failure to provide appropriate receipts. At 518, if the participant, thereafter, sends a receipt in, the EFA system proceeds with the adjudication process.

At 520, if the e-claim's matching receipt was received, but the receipt does not have enough information to determine whether the product or service purchased qualifies under the benefits plan, the EFA system sets the admin code to DCN10, referred to as data correction notice. Setting the admin code to DCN10 automatically triggers a DCN letter or e-mail to be generated. The letter or e-mail informs the participant, for example, that the information supplied is incorrect or incomplete, and the participant has ten days to send the appropriate information. The letter or e-mail is sent to the participant by email or any other known method. At 521, an indication is set that the EFA system is unable to proceed with the approval if the receipt is not received. If the receipt is received, the EFA system resumes its adjudication process.

If a receipt is not received within 10 days of sending the DCN letter or e-mail, the admin code automatically changes to DCN30, triggering a DCN 30-day letter or e-mail to be sent to the participant. The letters or e-mails inform the participant that more information is required to process the e-claims. At the same time the DCN 30-day letter or e-mail is sent, the EFA system may select to deactivate the card. Upon receiving the required information, the EFA system may reactivate the card.

At 522, the EFA system assigns IP (invalid partial) admin code to the e-claim, if after reviewing the receipt and any other information, it is determined that part of the spending was for the qualified products or services and part of the spending was not for the qualified products or services. In this case, the e-claim adjudicated is partially approved and partially denied. For the denied portion, a 10-day invalid partial letter or e-mail is sent to the participant requesting the participant to pay back the amount used for the non-qualified products or services. The admin code changes to IP30 at 524 if the payment is not received within the required 10 days of the request. At 526, the IP30 letter or e-mail is generated, further requiring the reimbursement of non-eligible funds and the card may be deactivated. The EFA system may also notify the employer as shown at 516. At 528, if a payment is received, the admin code is changed to repaid/claim closed and the transaction is completed.

At 530, if the EFA system matches an e-claim with a receipt and the receipt indicates that all products or services purchased using the card were qualified products or services, the admin code is set to approve. The transaction then is complete.

At 532, if the e-claim has a matching receipt, but the receipt indicates that none of the products or services purchased using the card qualifies under the benefits plan, the e-claim is assigned an admin code of IT10. Assigning the code IT10 automatically triggers a 10-day letter or e-mail to be generated and sent to the participant. The letter or e-mail requests that the participant pay back the total amount, and once received the money will be funded back to the participant's appropriate flex account.

At 534, if the money is not paid back within the required 10 days, the admin code automatically changes to IT30. At 536, IT30 code automatically triggers a 30-day invalid total letter or e-mail to be generated and sent to the participant, further requiring repayment of total disallowed amounts. At the same time, the participant's card may be deactivated. The EFA system may also notify the employer as shown at 516, of the funds that are required to be repaid.

When an IT10 or IT30 letter or e-mail is sent, the EFA system may embed a hyperlink in the e-mail letter. The hyperlink allows the participant to click on the link and go directly to a website where an electronic payment may be made to pay the amount back. The participant would supply a personal credit card number, for example, on the page of the website, for paying the amount to be put back into their appropriate account. At 538, if a payment is received for the invalid total, the admin code changes to repaid/claim closed, and the transaction is complete.

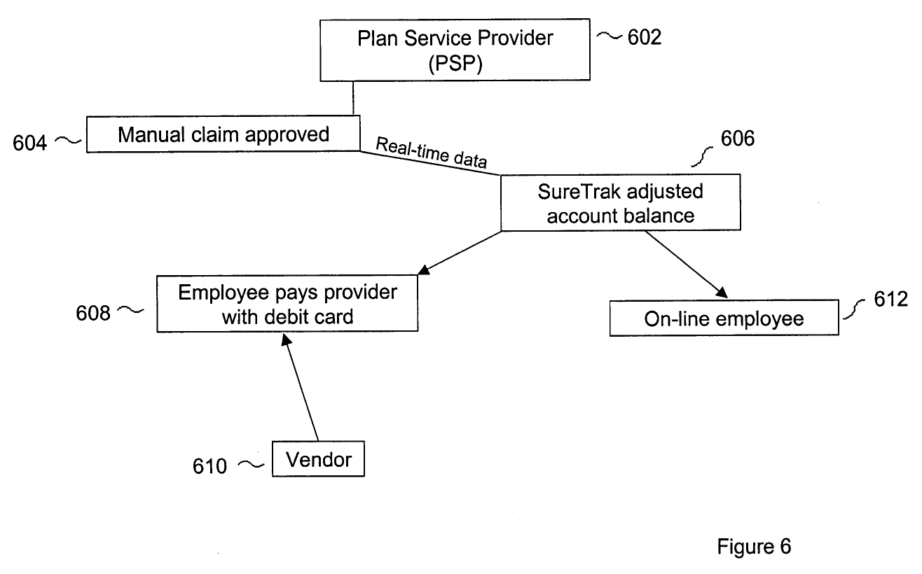

FIG. 6 is a diagram that illustrates the integration of the e-claims with the manual claims in one embodiment of the present invention. At 602, a plan service provider (“PSP”) receives a manual claim and decides whether to pay the reimbursement for the claim. At 604, the manual claim is approved and a payment is made to the participant. At 606, the PSP notifies the EFA system in real time or via batch file, that an amount has been paid to the participant, and therefore, the amount has been deducted from the appropriate account. The EFA system notifies the PSP of the manual payment made, so that the PSP is also aware of the current balance remaining in the account. At 608, when a merchant at 610, requests an e-claim, the PSP at 608 will be able to process the e-claim with an up-to-date balance of the account. At 612, an employee may check the status of the employee's flex account that is updated with both the e-claims and manual claims.

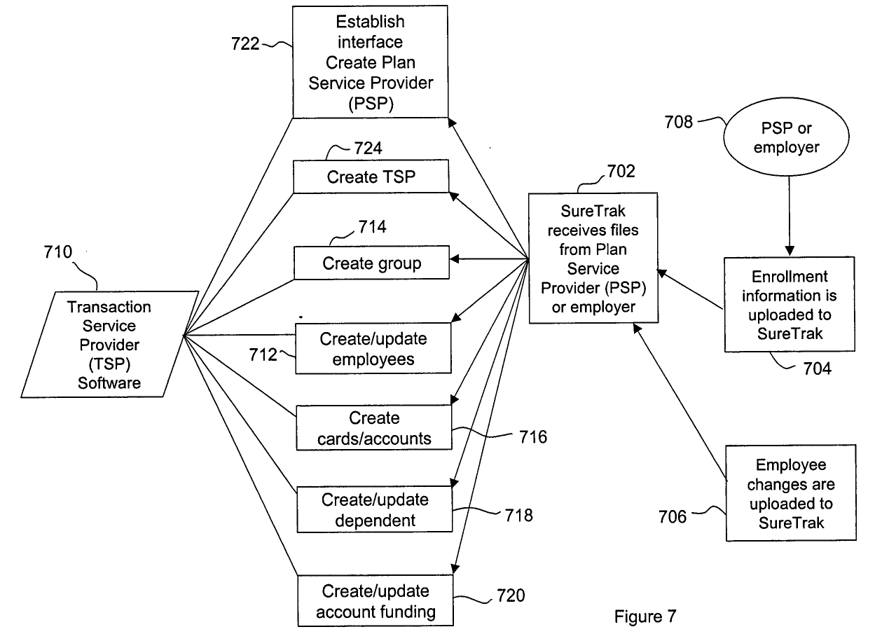

FIG. 7 is a flow diagram illustrating card administration in one embodiment of the invention. The EFA system provides administration tools that allow PSP's, employers and participants to access and administer the accounts. At 722, a new PSP account may be setup. The initial PSP data may be uploaded by an XML document, batch file, or may be entered via the Internet through a PSP load screen. The following information is used to setup a PSP account: PSP name, PSP address, PSP city, PSP state, PSP zip, PSP phone, PSP administrative fee amount, PSP contact first name, PSP contact middle initial, PSP contact last name, PSP e-mail, PSP tax identifier, PSP password, PSP card fee amount, PSP transaction fee amount, PSP deposit amount. A new PSP may be set up, for example, if an employer uses a new plan service provider (PSP) to manage its accounts.

At 714, a new employer account may also be set up in the EFA system for any new employers participating in the electronic flex card administration system. The employer data may be loaded via an XML document, batch file or may be entered via the Internet interface. In one embodiment, the following employer or company information is used to set up the employer account: name, address, city, state, zip, phone, e-mail, fax, contact name, tax identifier, group deposit amount, transaction fee amount, password, ER/EE fee pay, plan year start, plan year end, HCR account, DCA account, TRN account, PKG account, HRA and any applicable post tax accounts, banking information, payroll/calendar information, card fee amount. The EFA system sends this new information to the PSP also, for example, as an XML document.

The EFA system (at 702) receives all enrollment information at 704 such as employees, dependents, deductions, contributions information, etc. as well as any updates to enrollment data at 706 from the PSP or the employer at 708. The EFA system at 702 then establishes interfaces with the transaction service provider (TSP) at 710 to manage the new enrolled employee. For example, at 712, create employee interface is sent to the TSP to set up an account for the employee and to create a card for the employee.

At 712, for a new employee the following data are used: PSP ID, employer tax ID, start date, end date, social security number, date of birth, name, address, city, state, zip, phone, e-mail, HCR account information, DCA account information, transportation account information, parking account information, payroll/calendar information. At 718, dependent data information for additional dependents enrolled is also entered into the EFA system as shown at 718. This new information is sent to the TSP, for example, as an XML document.

Similarly, at 724, an interface to a TSP may be created for interacting with a TSP. The system and method of the present disclosure supports interactions with multiple TSPs. At 714, a new group may be created. At 716, a create card transaction is sent to the TSP 710 so that the TSP 710 may issue a new card. At 720, account balances are updated similarly.

The EFA system in one embodiment includes many management and monitoring functionalities. These management functionalities include ability to report on various statuses of the e-claims per employee, employer, sub-accounts, etc. Moreover, the EFA system includes a currency conversion capability, for example, for when an employee spends the flex account money via the card in another country. In this case, the balance in the employee's account is automatically and accurately adjusted even when foreign currencies have been used.

Another management functionality includes ability to monitor logons, adjudications, and various on-line queries by participants or employers. Further, the EFA system allows the different sub-accounts to have a different plan year. For example, a beginning period of a plan year may vary among different sub-accounts.

The EFA system in one embodiment of the present invention includes reporting capabilities enabling the participant, the employer and any other administrative personnel having access to the data to view the history of various data concerning the participant's e-claims and card usage. Table 1 is a sample list of the reports generated by the EFA system.

TABLE 1

| Current | |
|---|---|
| Report Titles | Report description |
| Active Account | shows total cards per account, shows total |
| List | dependents cards. |
| Claims Detail | ability to select by transaction status such |
| | as unapproved, pending, approved, denied, |
| | etc. |
| | ability to report final total amount of |
| | money for all accounts per participant. |
| | ability to report by date ranges. |
| | ability to run with or without fees. |
| | ability to report without merchant |
| | information for confidentiality purposes. |
| | ability to report reasons for denials. |
| Bank | ability to run for multiple Groups - for |
| Transaction | those sharing bank accounts. |
| Reconciliation | |
| Daily | ability to breakdown by account, with |
| Settlement | ability to combine multiple groups. |
| Reconciliation | ability to breakdown by social security, |
| | name, amount, fee, total. |
| | ability to breakdown by total per account/ |
| | total per client. |
| Disbursement | option to show without merchant name for |
| Detail | confidentiality issues. |
| | ability to add parameter by enrollee (detail |
| | for Customer Service usage.) |
| Enrollee List | ability to choose an enrollee by card |
| | status. |
| | can list everyone who has had a card in that |
| | plan year. |
| Enrollee | ability to retrieve manual transaction data |
| Negative | entries that are imported into EFA to adjust |
| Disbursable | account balances. |
| Balances | |
| Enrollee | ability to report account history to |
| Statement | participant, send enrollment verification |
| | statements and report on additional details. |
| | ability to include comment section for |
| | adding messages. |
| Enrollee | This is an accounting statement, summarizing |
| Ledger Summary | the funding transactions by account by |
| | participant. |
| Enrollee Year- | ability to insert group Logo/name. |
| End Statement | ability to breakdown deductions by manual or |
| | electronic claims. |
| | ability to add comment section, which can be |
| | by employee or group. |
| Current | ability to list currently available reports. |
| Report Titles | |
| Lost/Stolen | ability to report a list of all additional |
| or Replacement | cards replaced by PSP for the plan year. |
| Cards | |
| Plan Service | ability to list by Group, Employee, Account |
| Provider | Type. |
| (“PSP”) Manual | |
| Transactions | |
| PSP Settlement | ability to add by Group or multiple groups. |
| Much more | ability to report on Averages, percentages, |
| Group Level | totals by Account Type, Group, PSP: |
| Reporting for | Averages of usage (# of transactions, |
| evaluating, | Dollar Volume) |
| pricing, | Percentages by Account type by Group, PSP. |
| projecting | Percentage of used cards versus unused |
| usage | cards. |
| | Average amount in currency of transactions |
| | and currency volume by Account type, Group, |
| | PSP. |
| | Compare percentages and totals from Group |
| | to Group or Group to Total PSP activity. |
| | Percentage of approved claims versus |
| | ineligible claims. |
| | Monthly progression on transaction volume |
| | (summary and graph). |
| | Electronic versus Manual. |

The reports may be run on a selected number of fields, for example, by dates, groups, etc.

The EFA system of the present disclosure provides an Internet interface as well as other remote access, where various persons having access privileges, including participants and employers, can log on to the EFA system and generate reports, view a current status of the participant's account, or view various information. For example, a participant may log on to the system and view why a transaction is being denied, current account balance on various accounts associated with participants card, current information related to the participant, for example, to check for accuracy of information such as address, e-mail, or phone number. Employee may also view current usage and statements.

The following transaction information are some of the information that may be viewed by PSPs, employers, and participants according to their system privileges: name, ID number, PSP ID, employer tax ID, account balance, account number, account type, approval code, flex card number, administrative fee, effective date, last update, MCC, merchant ID, merchant name, merchant type, original transaction date, original settle date, original settle number, pending hold balance, plan ID, plan start, plan end, transaction flags, pre-authorization hold balance, TSP settle date, TSP settle number, transaction amount, transaction status, transaction type, transaction code, DCN code, user ID. The information is not limited to only this list.

Using the EFA system, PSP's may access or update many of the above transaction information. Moreover, in one embodiment, the EFA system allows employers and PSP's to deactivate or reactivate the participants' accounts remotely, for example, via the Internet. Further, a participant may request a replacement card, report a stolen or lost card, for example, via the Internet.

In another embodiment, the system and method of present disclosure allows for additional spending that is greater than the pre-tax limit set by the plans, for example, for sub-accounts such as the transit, parking and health care accounts. The new accounts can include post tax transit account, post tax parking account, post tax dependent care account and post tax healthcare account also known as an HRA. The pre and post tax transit and parking accounts are funded by the participant. For health care, participants fund the pre tax accounts while their company funds the post tax contributions on behalf of the participants. To illustrate, the transit plan currently allows for up to $100 per month for approved transit expenses. In many cases, this amount has shown to be insufficient. For example, a monthly transit ticket for commuter trains often amount to more than double the maximum allowed by the IRS. To accommodate purchasing of products or services greater than the limit set by the plan, the system in one embodiment makes more than $100 available to the cardholder. The amount of money that exceeds the maximum allowed pre-tax amount is considered post-tax. That is, this additional amount comes from after-tax income. For health care, for example, a participant may elect to set aside $500 in their pre tax healthcare account and their employer may fund $1000 in the participants HRA or post tax healthcare account. Normally funds are deducted from the pre tax healthcare account first and then from the post tax account although this order may be reversed.

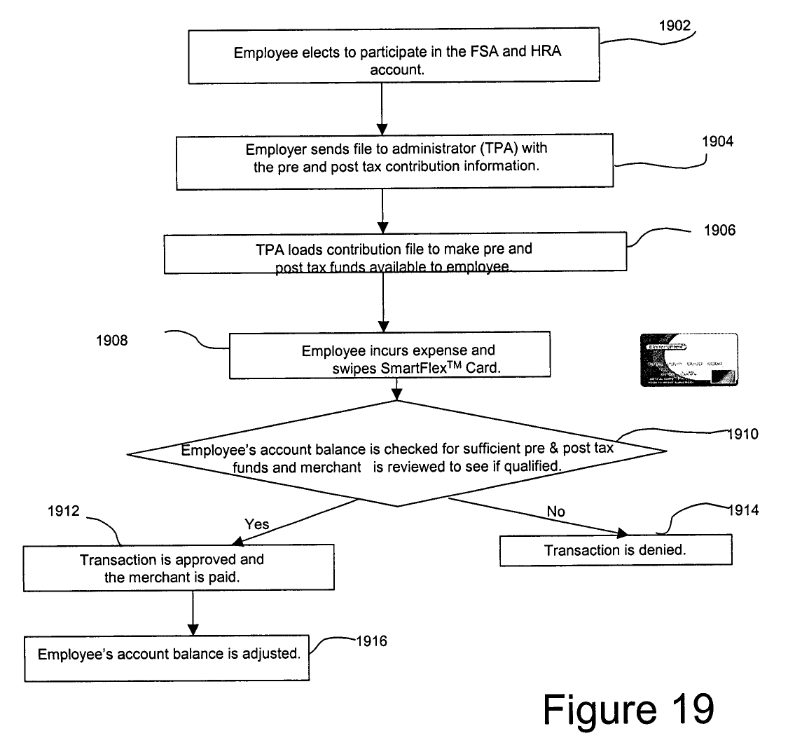

FIG. 19 illustrates an example of pre and post tax processing. An account holder or a participant in one embodiment may use the post-tax transit feature with either (a) payroll deduction (employer payroll system) (b) personal credit card payments or (c) employer contributions at 1902. During the enrollment process, an employee or employer may elect to create a post-tax payroll deduction or employer funded overflow account. This information is passed from the PSP via the EFA system to a TSP during the enrollment/account creation process at 1094. The payroll system of the employer allows the employee to specify an additional amount to be deducted on an after tax basis from their pay. This amount is reserved for post-tax purposes and the amount is submitted to the PSP. In one embodiment, the payroll feed (deductions file) to the PSP includes two deduction amounts, one for the pre-tax deduction and one for the post-tax deduction. Thus, in one embodiment, two balance adjustments are maintained. The first balance adjustment pertains to the pre-tax account. The second balance adjustment pertains to the post-tax overflow account as shown at 1906. At 1908, employee incurs an expense.

Spending transactions, that require more than the pre-tax account, overflow to the post-tax overflow account. Note this order can be reversed for the healthcare accounts whereby the post tax account is depleted first and then the pre tax account. If the available balance for the overflow account is enough to account for the remainder of the entire transaction, the transaction is approved at 1912. At 1916, account balance is adjusted accordingly. In one embodiment, if there are insufficient funds, the entire transaction is declined and no financial change occurs to the cardholder accounts including both the pre-tax and post-tax accounts as shown at 1914.

In another embodiment, the overflow amount for transit may be paid through a registered credit card. In this embodiment, participants register credit cards and an enhanced spending limit along with a pre-tax deduction amount at the time of enrollment. For example, if the expected expense is $250, the enhanced spending limit may be set to $250. The current IRS regulations allow the first $100 to be pre-tax, therefore $100 is expected to be deducted on a pre-tax basis. The remainder, the amount to be paid post-tax via credit card, is referred to as the credit card charge amount.

In one embodiment, the post tax transit allowance account needs to be pre-funded to enable an enhanced spending limit, that is, the post tax allowance accounts need to have a positive balance. The method and system of the present disclosure creates a batch file associating the participant's card account and personal credit card details along with a credit card charge amount. This file is uploaded into a TSP system, for example, for credit card charge processing. The TSP receives the batch file and processes each line in the file. The credit card details are submitted by the TSP with the charge amount to the electronic payment networks such as Visa, MasterCard, etc.

The electronic payment processor approves or declines the transaction in a similar manner as normal online merchant credit card processes are approved or declined. When the credit card charge amount is approved, the balance in the post-tax overflow account is increased. If the amount is declined, the system displays the rejected charge record, and triggers customer service processes. This processing may occur on a regularly scheduled basis such as weekly to ensure that funds are available for the participants to use their enhanced spending limit as needed.

The electronic payment processor collects funds from the personal credit cards, which are deposited into the participant's post-tax account. The electronic payment processor may deduct applicable fees. Payment failures, for example, in cases where the credit card company does not approve the post-tax value charge, may be listed in a batch status report. Each failed credit card charge may appear as a failed batch record. These records may be reprocessed in the system and method of the present disclosure, for example, for reporting purposes.

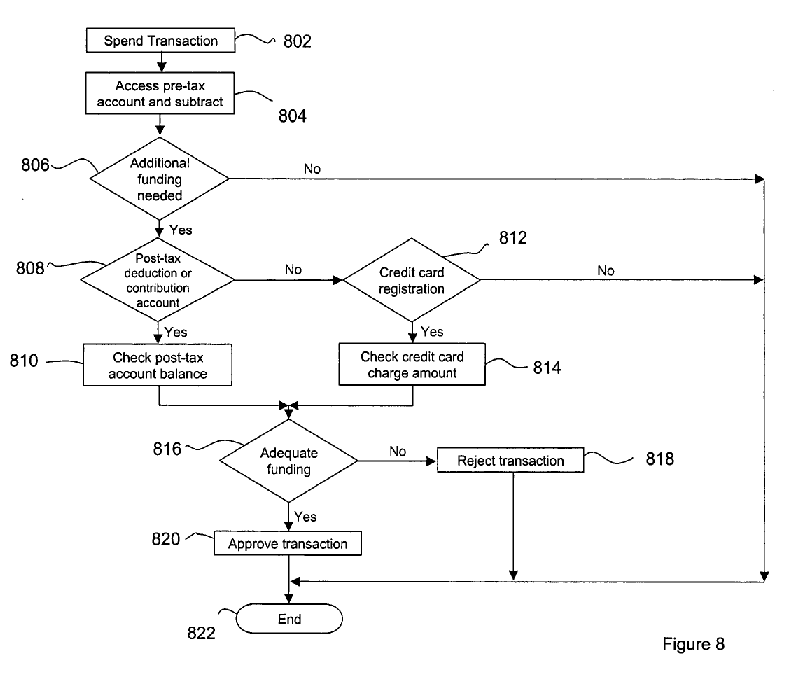

FIG. 8 is a flow diagram illustrating the spend transaction approval process in one embodiment. At 802, spend transaction is detected, for example, when a participant uses the card to purchase any products or services eligible for the plan. At 804, the participant's pre-tax account is accessed and the transaction amount is subtracted from the pre-tax account balance. At 806, it is determined whether additional funds are necessary to cover this transaction. For example, if the amount spent is more than the balance in the pre-tax account, additional funds are necessary to cover this transaction. This remainder is referred to as the post-tax spend amount. If no post-tax spend amount is necessary, the process proceeds to 822.

If post-tax spend amount is necessary to cover this transaction, at 808, it is determined whether the participant has set up a post-tax deduction account. If yes, then the post-tax account is accessed and the balance in that account is checked at 810. Otherwise, at 812, it is determined whether this participant has opted to pay the post-tax spend amount by credit card registration. If yes, then the credit-card charge amount is checked at 814. If there is no post-tax overflow account set up for this participant, the process proceeds to 822.

At 816, it is determined whether the post-tax overflow account has enough funds to cover the post-tax spend amount. If there are sufficient funds in the overflow account to cover the post-tax spend amount, the transaction is approved, the account balances are updated (deducted) accordingly at 820. If there are insufficient funds, the transaction is declined at 818, and the account balances do not change.

In one embodiment, the order of depleting the pre tax and post-tax accounts may be reversed. For example, a participant may choose to deplete post tax accounts prior to pre tax accounts.

In one embodiment, some spend transaction may come in with no previous associated authorization. These are known as forced-post settlements. Forced-post settlements may occur when a merchant, for example, processes a transaction manually without swiping a card for pre-approval. These transactions are processed in the similar manner as described above. That is, an amount from the pre-tax account is deducted and if necessary, the rest of the amount is deducted from the post-tax overflow account. If a negative balance occurs as a result of the deduction, the system and method of the present disclosure may block the card for future use automatically, and an appropriate negative balance report may be generated. Additional customer service processing may be performed to inform the participant of the negative balance.

In the event that a payroll deduction or credit card charge occurs between the date of the authorization and the settlement, typically 24-48 hours, the account balances may differ from when the original transaction took place. In one example, there may be sufficient funds to process the entire transaction from the pre-tax account, where previously an overflow account was required. In one embodiment, the transaction is processed consistent to the original holds, even if there is at settlement time a sufficient balance to process completely with the pre-tax account. This simplifies the situation where the credit card has already been charged but may not at settlement time be required. For example, if the card is swiped for $100 and at that time the pre-tax account has only $50, the remaining $50 would be taken from the post-tax account. Even if prior to the settlement a pre-tax contribution is received for $50, the transaction will be settled based on the original authorized amount of $50 pre-tax and $50 post-tax rather than adjusting it to $100 pre-tax.

Yet in another embodiment, the system and method in the present disclosure allows a participant to payback ineligible expenses via a website using, for example, a credit card, money-gram, or any other method known for paying electronically via the Internet. For example, a web site may include a server that processes the participant's credit card and returns the funds to the participant's account. This transaction is then recorded for appropriate balance adjustments.

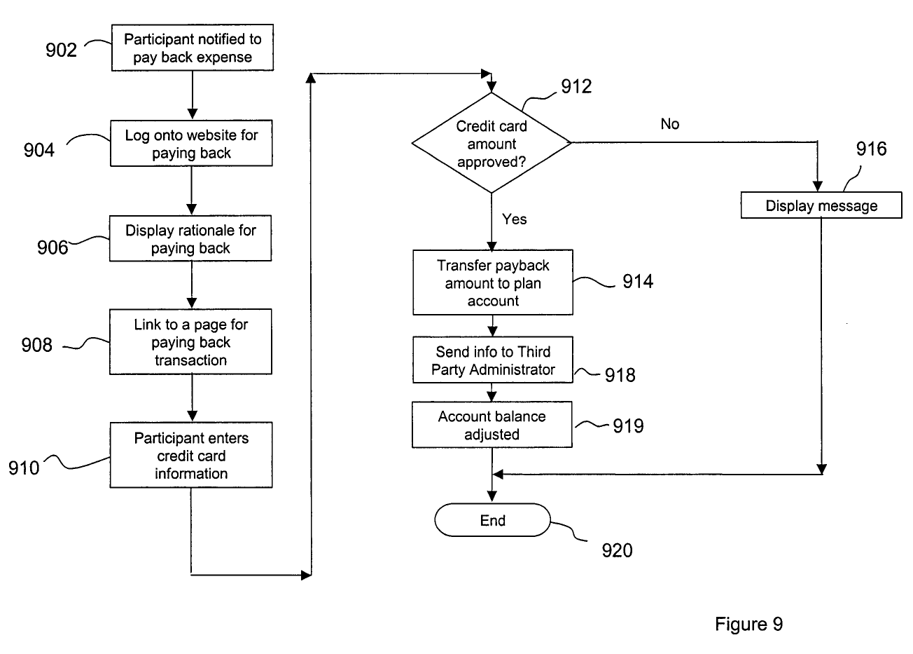

FIG. 9 is a flow diagram illustrating the pay back process using the Internet in one embodiment. At 902, participant receives an adjudication letter or e-mail and is informed to log or click on to a website to payback the ineligible amount. At 904, the participant logs on the website provided. From the website, the participant sees links on the web page for transactions that have ineligible administrative codes. Each link connects to a detailed page explaining the reason why a transaction was declined or denied. At 906, the reason for the need to pay back funds is explained, for example, on the web page.

A button on that page may link the participant to a site that is enabled to process money or credit card transactions, for example, a web site provided by a transaction service provider enabled to process credit cards as shown at 908. The transaction identifier (ID) and payment amount (since ineligible amount may be part of overall transaction amount) are also passed to that site. For example, a URL request containing parameters for transaction ID and amount to pay may be sent to the web site. The web site is enabled to look up the transaction ID, and retrieve additional information for that transaction such as cardholder and account information. The website then may display a credit card payment page. In one embodiment, the name and address details may be edited, however, the amount to pay is left as a fixed field, and reflects the amount passed in as one of the parameters in the URL.

On this web page, the participant sees the transaction ID and the amount to be paid with fields to enter credit card information as shown at 910. At 912, credit card amount is approved or disapproved. If disapproved, an appropriate message is conveyed to the participant at 916, logged, and the processing ends at 920. The participant then may use another method to pay back. At 914, if the credit card is approved, the amount is transferred to the participant's plan account. At 918, the information that this participant has paid back the amount for ineligible spending is sent to the TSP and various databases are updated to record the same, and at 919, account balances are adjusted.

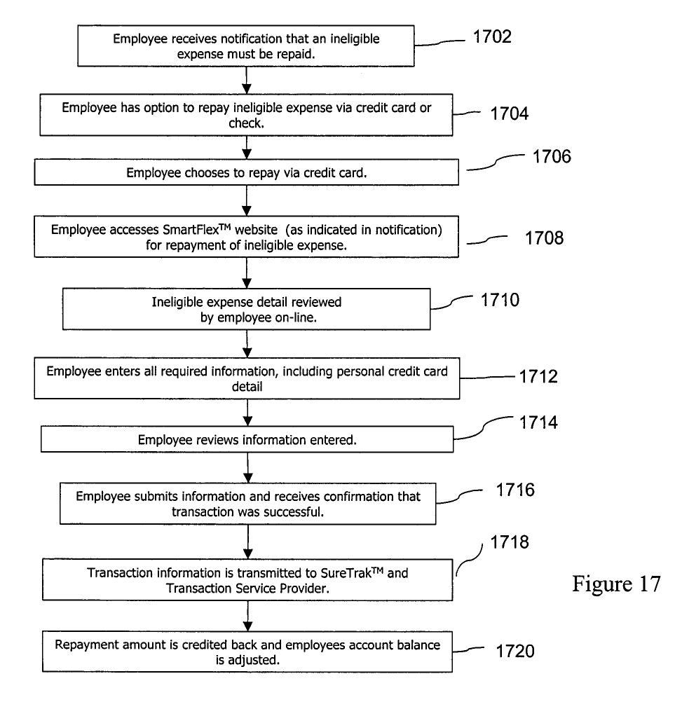

FIG. 17 is a flow diagram illustrating a pay back process in another embodiment. When a transaction occurs, for example, using an electronic card, a third party administrator (TPA) reviews the transaction and corresponding receipts to make sure that it is a qualified expense under current IRS regulations. If the TPA finds that the employee received payment for an ineligible expense they notify the employee of the requirement to make repayment or refund. Accordingly, at 1702, an employee receives notification that they have received payment for an ineligible expense and they are required to refund or repay that amount to their account. At 1704, the employee has an option to repay the ineligible expense via, for example, personal credit card, check, money order, or other similar means. At 1706, the employee chooses to repay the ineligible expense via personal credit card. At 1708, the employee accesses a website indicated in the notification, for example, SmartFlex™ website, for repayment of ineligible expenses.

At 1710, the ineligible expense detail are provided via the website to the employee for the employee to review on-line. At 1712, the employee enters the required information, for example, information related to the employee's credit card details. At 1714, the employee may review the information entered for accuracy. At 1716, the information is submitted and confirmation is sent back to the employee that the repayment transaction was successful. At 1718, the repayment transaction information is transmitted to the EFA and transaction service provider (TSP). At 1720, the repayment amount is credited back and the employee's account balance is adjusted to reflect the repayment.

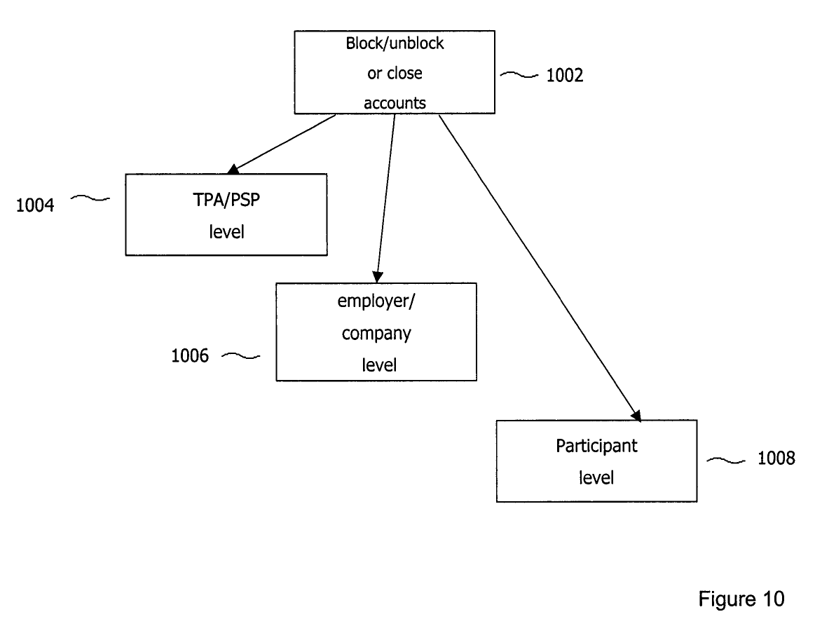

Yet in another embodiment, the system and method includes an ability to suspend or block authorization requests to approve a transaction. FIG. 10 is a block diagram illustrating the blocking, unblocking, and/or closing of a card in one embodiment. As shown in FIG. 10, a suspension or blocking may be enabled for participants individually 1008, particular companies (employers) 1006, or for all participants serviced by a particular plan service provider (PSP) 1004.

For example, employers may have trouble meeting payments in a timely fashion. For these employers, the system is enabled to reject all requests from cards associated with that employer. An administrative functionality via a user interface, for example, may be used to allow administrators and managers to block or unblock PSP, company (an employer), or an individual participant.

Also as shown in FIG. 10, the system and method of the present disclosure enables closing multiple accounts without having to close an account on one-by-one manual basis. This functionality may be used, for example, when an entire company or a group of employees at the company no longer use the service. In the case of an entire company, all cards associated with that company are deactivated automatically. In one embodiment, when a primary card is deactivated, all dependent cards associated with the primary card are automatically deactivated or blocked.

In one embodiment, three online administrative actions may be used to provide this termination functionality. The first administrative action includes a “block card” functionality that blocks or deactivates all card numbers linked to one or more accounts, including dependent cards. No spending activity may be authorized on these cards after the block functionality is applied.

The second administrative action includes an “unblock card” functionality that removes a block on a card number and all cards linked to the associated accounts. This functionality generally reverses the effect of the block card functionality.

The third administrative action includes “close user” functionality that changes the status of one or more accounts to “closed.” If an attempt is made to close an account having a negative balance, an exception is raised and the close transaction may fail.

In one embodiment, forced posts, for example, settlement with no matching active authorization, may still be applied to blocked and deactivated accounts. The forced posts are typically part of the electronic payment process, but correction of these unauthorized settlements may be available by the chargeback process, for example, declining the settlement and not paying.

In another embodiment, the system and method allows customer service agents from PSPs to access transaction data related to failed transactions. Thus, the customer service agents may provide more detailed and accurate rationale for transactions that were declined. This is achieved, for example, by providing the PSPs with online real-time access to card transaction data. If a card transaction is denied, a customer representative may view the system for reason codes such as insufficient funds, invalid merchant, etc.

In one aspect, the cards are filtered (MCC filtering) by one or more Merchant Category Codes (MCC). For example, merchant categories other than qualified categories of health, dependent care, transit, and parking may be blocked. Thus, the card may not work at a restaurant, electronics store, etc. The filtering can be done at a participant level, a client level a PSP level or at the SmartFlex program level.

The system and method of the present disclosure in one aspect monitors and tracks failed authorization attempts in real-time. Each failed attempt may be recorded in the system, for example, in real-time. An administrator thus may access these recorded attempts, for example, to determine reasons for failures. For example, the recorded data may indicate that the user does not know how to use the card, or that the card is stolen. Such determination may provide, for example, fraud protection for the cards.

For example, the cards may be filtered by MCC and cardholders may be provided details about where they can use their card. If cardholders use their cards at a blocked MCC (an ineligible merchant where the transaction is declined), this misuse is tracked on a real-time basis. This tracking allows the system and method to monitor this activity to help detect misunderstandings on the individual's part or potential fraud attempts.

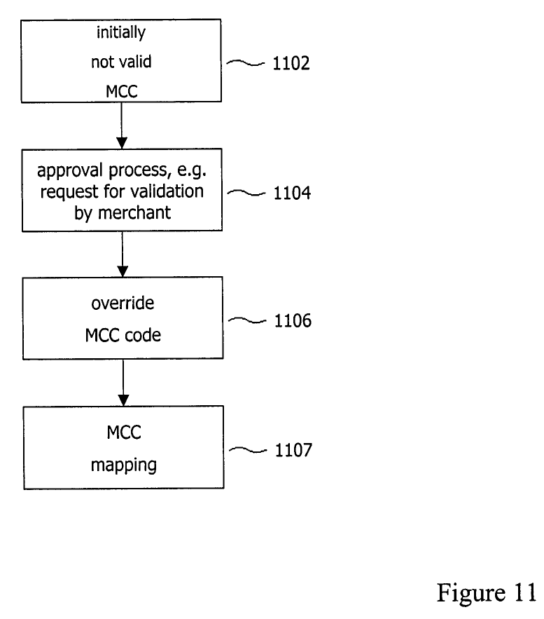

In another embodiment, Merchant Category Code (MCC) overrides is enabled on a per cardholder, per client, per PSP or EFA basis. FIG. 11 shows an example of an override process. Overriding MCC may be necessary, for example, if a merchant terminal has an MCC that is not correct. In other cases, overriding MCC may be necessary if a merchant provides more than one type of a service, but is configured for only a certain service. The system and method of the present disclosure includes the ability to override MCCs for cards associated with a particular client and map the client's MCC to an eligible plan.

For example, if a cardholder is receiving day care at a YMCA and that YMCA's MasterCard box has an MCC of fitness, the cardholder's card will not work there. This for example is shown at 1102. Once validated 1104, however, the system and method is set up to recognize the day care expenses so that the cardholder may use the card. This overriding of MCCs 1106 may be performed on a real-time basis. The validation may be performed, for example, by an office manager at YMCA calling up to request validation. In one embodiment, the MCC history for each merchant is recorded and tracked. The MCC override function described with reference to FIG. 11 may be performed on a participant level, PSP level, or for all users of the EFA.

In yet another aspect, when it is confirmed that a merchant is qualified but has been assigned an improper MCC code, at 1107, the merchant's specific terminals can be mapped to accept future qualified expenses automatically.

Yet in another aspect, the system and method provides a web-based tool to access and get settlement reports by, for example, a PSP. Reports that show aggregate settlements may be created by a PSP for a specified date range. Report selection criteria may include PSP program or sub program, start date, end date, or report by day option. Such selection criteria may generate a report showing the sum of debit settlements for the date range by month, sum of credit settlements for the date range by month, sum of debit settlements for the date range by day, sum of credit settlements for the date range by day, and similar settlement details for each of the programs or clients under that PSP.

Further yet, the adjudication to determine whether a transaction made with a card is eligible under one of the benefits plans may be performed without receiving a receipt. For example, an internal table that holds eligible amounts for an MCC may be created and checked against when a transaction is made at the MCC. If the amount of the transaction matches with the amount in the table, the transaction may be approved as qualified. For example, if a company has a health plan that has an Rx or doctor's office visit co-payment of $10.00, the table is established showing the applicable co-payment. When a participant goes to the pharmacy or doctor and receives approval to fill the Rx or is treated by the doctor, the system verifies the MCC, the balance in the participant's account and the co-payment amount. If all match, the transaction is approved.

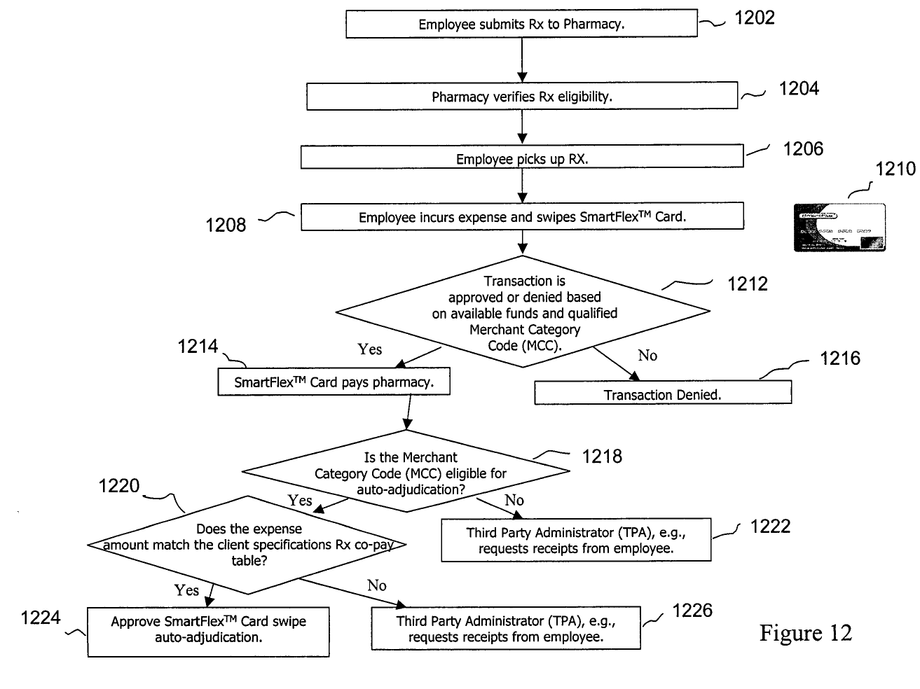

FIG. 12 is a flow diagram illustrating an example of auto-adjudication process in one embodiment. Although FIG. 12 is illustrated with reference to a pharmacy as being an example of a merchant, the auto-adjudication or the present disclosure may be applied to other merchants. At 1202, an employee receives a prescription from a physician and takes it to a pharmacy to be filled. At 1204, the pharmacy verifies the employee's eligibility for the prescription and dispenses the prescription. At 1206, the employee picks up the prescription from the pharmacy. At 1208, the employee “swipes” the card 1210 to pay for the prescription with pre-tax funds. At 1212, the employee's account is checked for sufficient available funds. In addition, a determination is made as to whether the merchant, that is, the pharmacy, is an authorized merchant for providing services or items that are qualified, for example, as defined by the IRS code by looking up eligible merchant category code (MCC). At 1216, if the pharmacy has an ineligible MCC or there are insufficient funds available in the employee's account, the transaction is denied.

At 1214, if the pharmacy is associated with an eligible MCC and sufficient funds are available in the employee's account, the transaction is approved. At 1218, it is determined as to whether this merchant is eligible for auto-adjudication. If, for example, the merchant is a doctor's office or a similar provider that has a predetermined payment schedule such as $10 co-payment, the merchant is eligible for auto-adjudication. At 1222, if the merchant is not eligible for auto-adjudication, the employee is requested to send in the receipts, for example, by a PSP.

At 1220, if the merchant is eligible for auto-adjudication, it is determined as to whether the amount of expense incurred matches a co-payment amount under this employer's prescription plan. At 1224, if the transaction amount matches the employer's co-payment requirement, the transaction is approved for auto-adjudication. A code specifying auto-adjudication, for example, code “A”, may be entered into logs for this transaction. At 1226, if the amount incurred at the pharmacy does not match the co-payment amount, the auto-adjudication is denied, and the employee is requested to send in the receipts, for example, by a PSP.

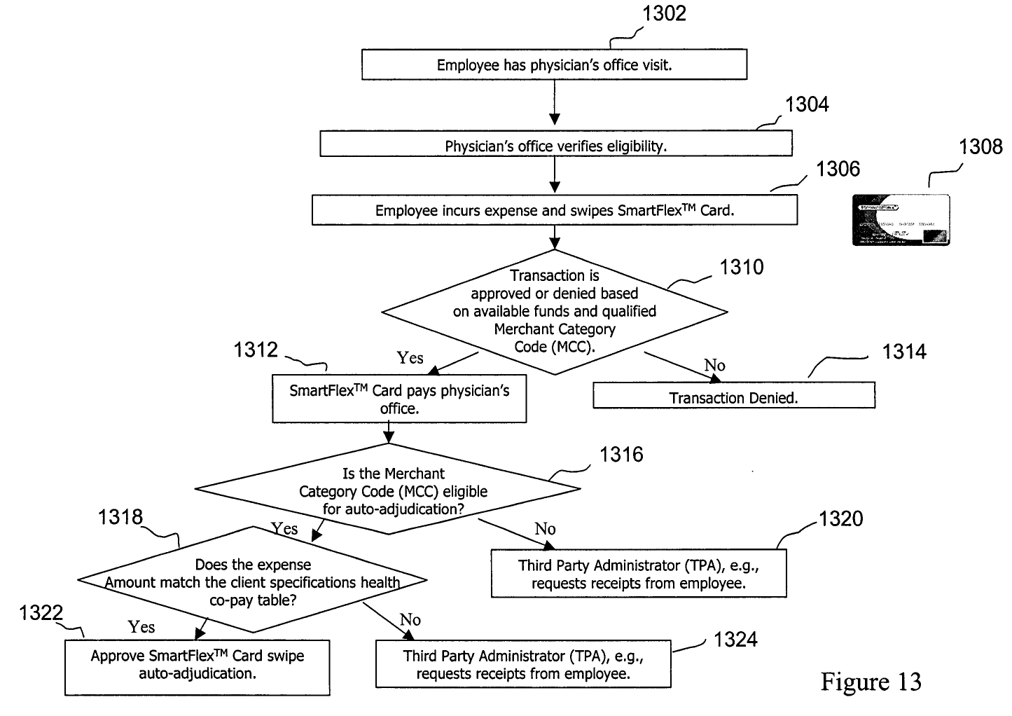

FIG. 13 is a flow diagram illustrating another example of auto-adjudication in one embodiment. At 1302, an employee visits a physician's office. At 1304, the physician's office checks the employee's coverage under a medical plan. At 1306, the employee pays for the expenses incurred at the physician's office by using the card, for example, “swiping” the card 1308. At 1310, the employee's account is check for sufficient funds. In addition, a determination is made as to whether this physician's office has an eligible MCC. If the MCC is not eligible or if the employee's account does not have sufficient funds, the transaction is denied at 1314. If the MCC is eligible and the employee's account has sufficient funds, the amount incurred is paid to the physician through the card processing at 1312. At 1316, a determination is made as to whether the MCC for this physician is eligible for auto-adjudication. At 1320, if the MCC is not eligible for auto-adjudication, the employee is requested to send in the receipts, for example, by a PSP. At 1318, if the MCC eligible for auto-adjudication, it is determined whether the expense amount matches the co-pay amount required by the employee's healthcare plan. At 1322, if the amounts match, auto-adjudication is approved. Otherwise, at 1324, the employee is requested to send in the receipts, for example, by a PSP.

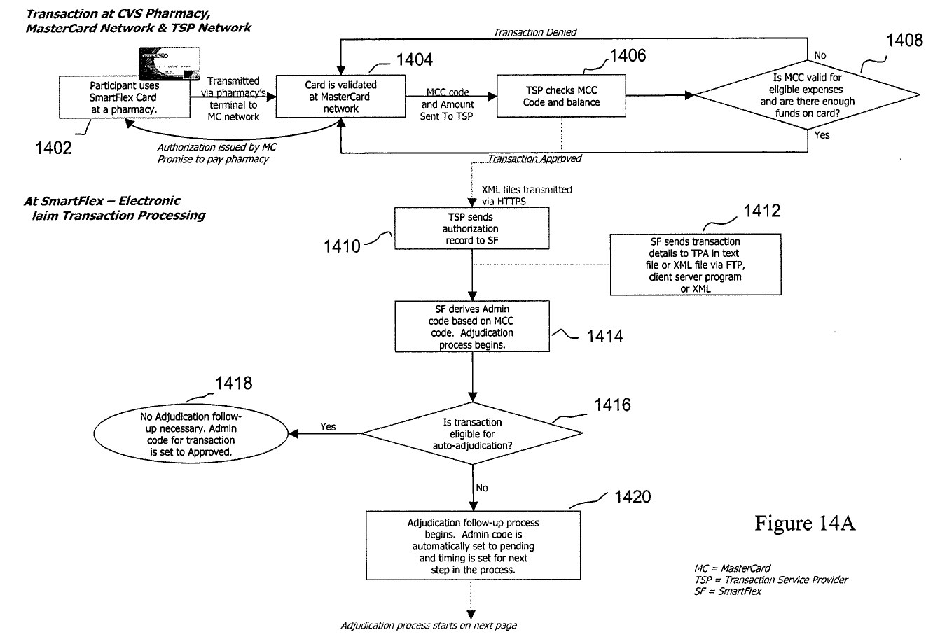

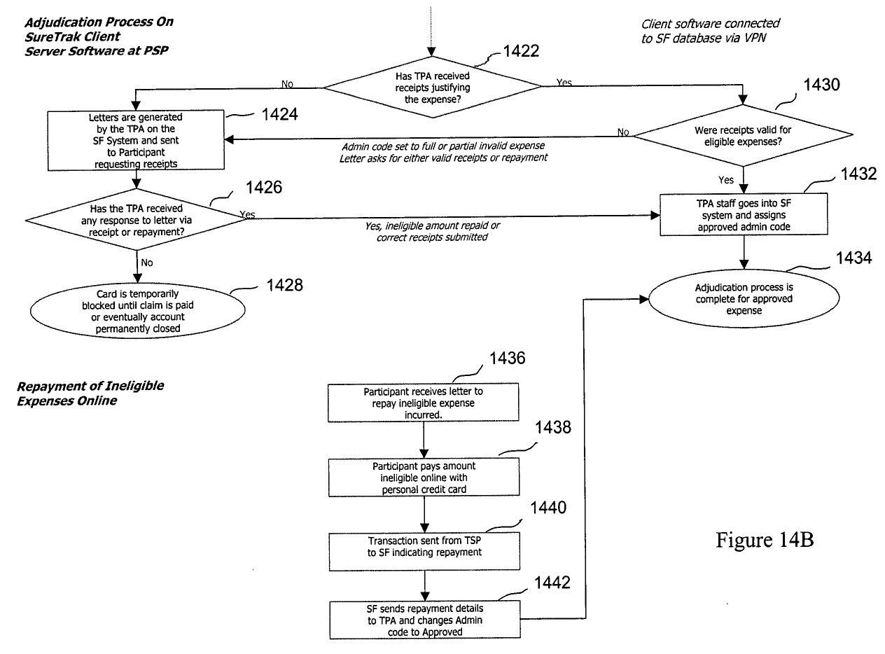

FIGS. 14A and 14B is a flow diagram illustrating an overview of the electronic card transaction in one embodiment. At 1402, a participant, for example, an employee of a company that sponsors the benefits plan uses the card at a pharmacy to pay for expenses. This transaction is transmitted to an appropriate credit card network. At 1404, the card transaction is validated at the appropriate credit card network, for example, MasterCard network. From the credit card network, a merchant category code (MCC) of pharmacy and the amount of the transaction is sent to a transaction service provider (TSP). At 1406, the TSP checks MCC and the balance in this participant's account. The TSP may also check whether the transaction is within the IRS approved monthly amounts, for example, for transit and parking expenses. At 1408, if MCC is valid, the expense does not exceed plan limits and there are enough funds in the participant's account, the transaction is approved. A message is sent to the credit card network to approve the transaction. The credit card network then authorizes payment to the pharmacy. Otherwise, at 1408, if MCC is not valid or sufficient fund is not available in the participant's account, the transaction is denied. The disapproved transaction is sent back to the pharmacy via the credit card network, in which case, the participant needs to pay for the expenses incurred out of his/her own pocket.

It the transaction is approved, the TSP transmits the transaction information data via the EFA system to the PSP. At 1410, the transaction information data is transmitted, for example, in an XML (extensible markup language) file format via HTTPS (hyper text transfer protocol secure), to a claim processing system. At 1412, the claim processing system may transmit the transaction information data to a PSP in text file format via FTP (file transfer protocol) or client server program, or in XML format via HTTPS. At 1414, the claim processing system assigns an administrative code to this transaction based on MCC received in the transaction information data.

At 1416, a determination is made as to whether this transaction is eligible for auto-adjudication. Transactions that are eligible for auto-adjudication may include transit, parking, healthcare and other transactions having a pre-set co-payment rules. Auto-adjudication process was described with reference to FIGS. 12 and 13. If the transaction is eligible for auto-adjudication, no additional follow up procedures are taken.

At 1420, if the transaction is not eligible for auto-adjudication, adjudication follow-up process begins. For example, the administrative code is set to pending and a timer is set to a predetermined number of days for one or more follow-up processes. The predetermined number of days sets an allowable time to receive receipts before taking further actions. On expiration of the timer at 1422, a next follow-up process begins. The next follow-up process, for example, may be a letter or email sent to a participant at 1424. At 1426, it is determined, for example, after another predetermined number of days, whether any responses to the letter or email were received from the participant. The responses, for example, may be in the form of receipts or a repayment by check or online repayment as described with reference to FIG. 9. At 1428, if no responses were received, the card may be blocked or suspended until the claim is paid. The participant then may only be allowed to send in manual claims.

At 1430, if receipts are received, a determination is made as to whether the receipts indicate valid expenses. If the receipts do not indicate valid expenses, the processing resumes to 1424. If the receipts are valid, that is, the expenses were qualified expenses, an approval code is assigned to the transaction at 1432. At 1434, the transaction is approved and the adjudication process for this transaction is complete.

At 1430, if the receipts do not indicate valid expenses, the participant may be notified at 1424, to pay back the ineligible amount used on the card. At 1436, the participant receives the notification to pay back for ineligible expenses incurred. At 1438, participant pays-the amount back, for example, using an online repayment method. At 1440, the repayment transaction is transmitted from the TSP to the EFA. At 1442, the repayment transaction information is transmitted to the PSP, for example, via the EFA. The PSP, for example, may then assign an approved code to the transaction. At 1434, the adjudication process completes for this transaction.

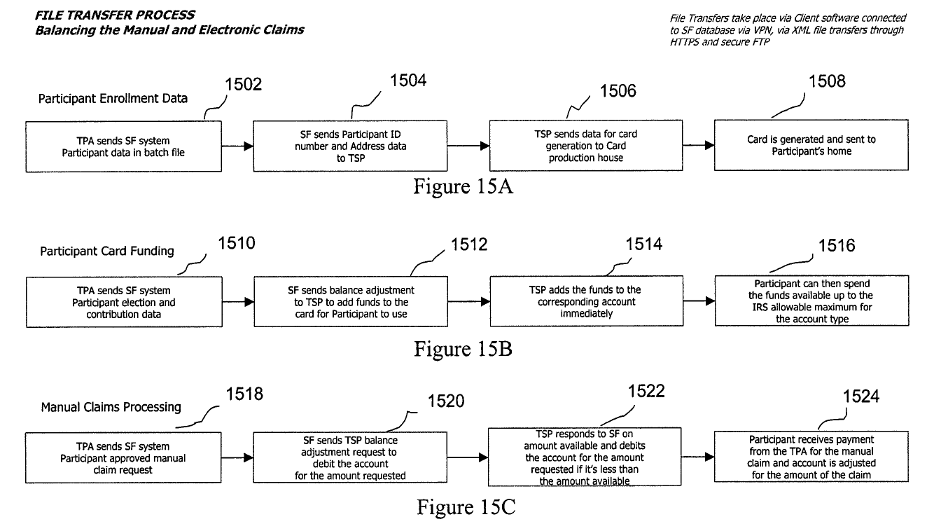

FIG. 15A is a flow diagram illustrating participant enrollment data file transfer process in one embodiment. At 1502, PSP sends the participant data, for example, in a batch file, to the EFA. At 1504, the EFA sends participant information such as identifier (ID) number and address data to TSP. At 1506, TSP sends data for card creation to a card production company. At 1508, a card is generated by the card production company and is sent to the participant.

FIG. 15B is a flow diagram illustrating participant card funding file transfer process in one embodiment. At 1510, PSP sends the participant election and contribution data to EFA. At 1512, EFA sends positive balance adjustment to TSP to add funds to the card in order for participant to begin using the card. For health care accounts, the entire year's election may be available. At 1514, TSP adds the funds to the corresponding account. At 1516, the participant is allowed to spend the funds available up to the IRS allowable maximum for the account type.

FIG. 15C is a flow diagram illustrating data file transfer process in one embodiment in a manual claim processing. At 1518, PSP sends a participant approved manual claim request to the claim processing system. These are paper claims received by the PSP from the participant for out-of-pocket expenses not incurred via the card. Before making a payment to the participant for the approved manual claims, the PSP sends a request to the EFA to check that the claim is within the available balance and to place a hold on those funds;. Putting a hold ensures that the participant does not spend this amount on another purchase. At 1520, EFA sends a negative balance adjustment to TSP to debit the account for the amount requested. At 1522, TSP debits the amount available for the account. At 1524, the participant receives payment from the PSP from the manual claim if the amount was available in the participant's account.

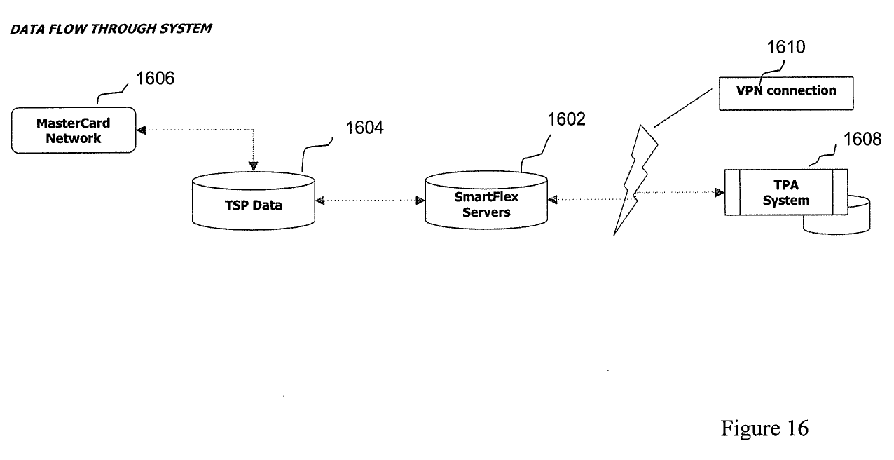

FIG. 16 is a block diagram illustrating system interfaces in one embodiment. TSP 1604 interfaces to a credit card network, for example, MasterCard network 1606. TSP 1604 also connects to EFA 1602 for transferring information, for example, via HTTPS for transfer of XML files. The claim processing system 1602 interfaces with PSP system 1608, for example, over a secure VPN connection 1610. Data may be transferred between EFA 1602 and the PSP system 1608 in the form of text files. User interface to EFA 1602 may also be connected via the VPN 1610. In general the files may be transferred among the systems using direct transmission of XML files via HTTPS connection and/or FTP transfer of data files.

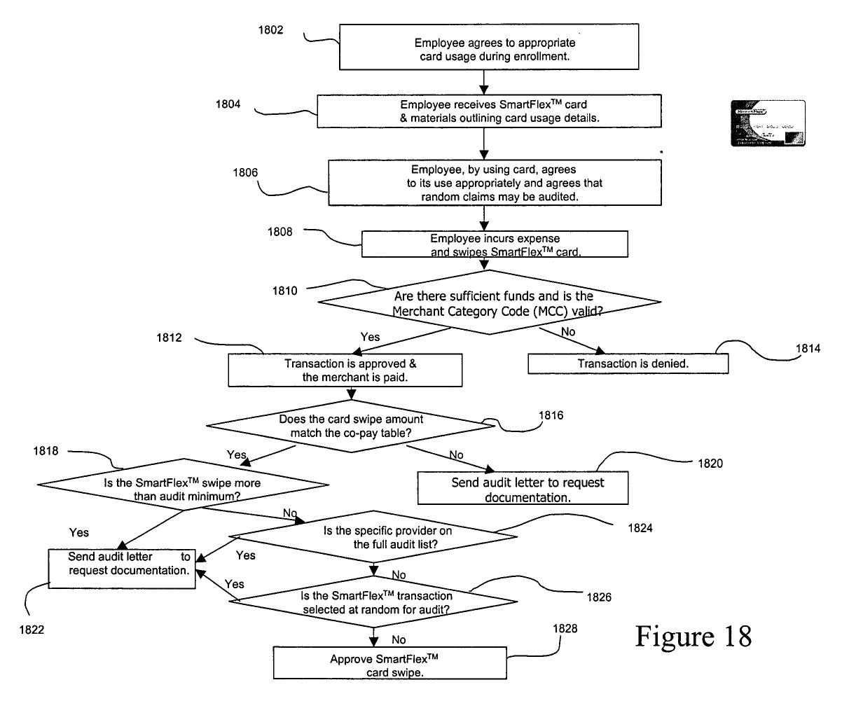

FIG. 18 is a block diagram illustrating a random audit process in one embodiment. At 1802, an employee or a participant agrees to comply with appropriate card usage during enrollment period. At 1804, the employee receives an electronic card and materials outlining card usage details, for example, as determined by the issuing institution, TPA, and EFA. At 1806, the employee, by using the card, agrees to its proper use and that random claims may be audited. At 1808, the employee incurs expense and uses the card, for example, swipes the card at the merchant location for payment of a qualified expense.

At 1810 the merchant category code (MCC), a universal coding system used to determine the type of business or service provider, is checked for eligibility as a qualified match for use under the benefits program. At 1812, if the MCC is eligible and sufficient funds are available, the transaction is approved and the merchant is paid. At 1814, if the MCC is ineligible or there are not sufficient funds, the transaction is denied.

At 1816, the transaction is checked to determine if the amount spent matches the co-pay table. At 1818, if the transaction matches the co-pay table, it is checked to determine if it is more than the audit minimum. At 1820, if the transaction does not match the co-pay table, an audit letter is sent by the TPA requesting documentation on the transaction. At 1822, if the transaction is more than the audit minimum, the TPA sends a letter requesting documentation on the transaction. If the service provider or merchant is on the full audit list, the TPA sends a letter requesting documentation on the transaction. If the transaction is selected for audit, the TPA sends a letter requesting documentation on the transaction. At 1824, if the transaction is not more than the audit minimum, it is checked to determine if the specific service provider or merchant is on the full audit list. At 1826, if the service provider or merchant is not on the full audit list, the transaction may be selected at random for audit. At 1824 and 1826, if the transaction is determined for audit, the process continues to 1822. At 1828, if the transaction is not selected for audit, the transaction is approved.

The EFA system of the present disclosure allows compliance with the current applicable IRS requirements. The EFA system may be programmed in any known computer language, for example, Visual Basic, and run on any platform, e.g., Windows® operating system.

While the invention has been particularly shown and described with respect to particular embodiments thereof, it will be understood by those skilled in the art that the foregoing and other changes in form and details may be made therein without departing from the spirit and scope of the invention.

We claim:

1. A method of processing transactions involving an account reserved for qualified spending, comprising:
automatically receiving transaction data associated with a purchase to be paid from an account reserved for qualified spending;
determining whether the purchase is a qualified transaction for which payment can be made from the account, the determining including at least automatically determining that the purchase is a qualified transaction if a merchant code from which the purchase is made matches a predetermined automatic adjudication merchant code and an amount of the purchase matches a predetermined automatic adjudication amount; and
requesting a refund if it is determined that the purchase is not a qualified transaction.

2. The method of claim 1, further including:
sending a request for a receipt associated with the purchase, if the receipt has not been received; and
the step of determining includes verifying whether the purchase is a qualified transaction by auditing the receipt if the receipt is received.

3. The method of claim 1, further including:
requesting for the receipt periodically until the receipt is received.

4. The method of claim 1, further including:
requesting for the refund periodically until the refund is received.

5. The method of claim 1, further including:
providing a post-tax account from which an amount of money for the purchase may be deducted if the account does not have a sufficient amount for the purchase.

6. The method of claim 5, wherein the post-tax account includes post-tax contributions.

7. The method of claim 5, wherein the post-tax account includes an amount approved on a credit card.

8. The method of claim 5, wherein if the post-tax account has insufficient funds to cover the purchase, no amount is taken out from the post-tax account.

9. The method of claim 1, further including:
allowing a user to connect to a web site for making payments.

10. The method of claim 9, wherein the allowing includes sending a URL request for a website through which the user can make a payment.

11. The method of claim 10, wherein the user can make the payment using a credit card.

12. The method of claim 1, further including:
allowing automatic disabling of all accounts for all users under a particular plan service provider.

13. The method of claim 1, further including:
allowing automatic disabling of all accounts for all users under a particular employer.

14. The method of claim 1, further including:
allowing automatic disabling of all accounts for all users under a particular participant.

15. The method of claim 1, further including:
checking a merchant category code before the purchase is authorized.

16. The method of claim 15, further including:
allowing one or more purchases to be made from a merchant without the one or more valid merchant category codes if a predetermined condition is met.

17. The method of claim 16, wherein the predetermined condition includes a condition that the merchant has been approved.

18. The method of claim 1, further including:
providing one or more reasons for disqualifying the transaction.

19. The method of claim 1, further including:
checking a merchant category code before the purchase is authorized.

20. The method of claim 1, further including:
checking whether an account has sufficient funds for the purchase before the purchase is authorized.

21. The method of claim 1, further including:
receiving an amount of adjustment in an account made due to a manual payment; and
updating an account balance by the amount.

22. The method of claim 1, further including:
transmitting an amount of adjustment made due to direct payment from the account, wherein a PSP processing manual payments receives the amount and updates an account balance by the amount.

23. The method of claim 1, further including:
blocking the account if the receipt is not received within a predetermined amount of time.

24. The method of claim 1, further including:
blocking the account if the refund is not received within a predetermined amount of time.

25. The method of claim 1, wherein the purchase is made by using an electronic card issued to a participant.

26. A method of processing transactions involving an account reserved for qualified spending, comprising:
automatically receiving transaction data associated with a purchase to be paid from an account reserved for qualified spending; and
determining whether the purchase is a qualified transaction for which payment can be made from the account, the determining including at least automatically determining that the purchase is a qualified transaction if a merchant code from which the purchase is made matches a predetermined automatic adjudication merchant code and an amount of the purchase matches a predetermined automatic adjudication amount.

27. A program storage device readable by machine, tangibly embodying a program of instructions executable by the machine to perform method steps of processing transactions involving an account reserved for qualified spending, comprising:
automatically receiving transaction data associated with a purchase to be paid from an account reserved for qualified spending;
determining whether the purchase is a qualified transaction for which payment can be made from the account, the determining including at least automatically determining that the purchase is a qualified transaction if a merchant code from which the purchase is made matches a predetermined automatic adjudication merchant code and an amount of the purchase matches a predetermined automatic adjudication amount; and
requesting a refund if it is determined that the purchase is not a qualified transaction.

28. The program storage device of claim 27, further including:
sending a request for a receipt associated with the purchase, if the receipt has not been received; and
the step of determining includes verifying whether the purchase is a qualified transaction by auditing the receipt if the receipt is received.

29. The program storage device of claim 27, further including:
providing a post-tax account from which an amount of money for the purchase can be deducted if the account does not have a sufficient amount for the purchase.

30. The program storage device of claim 27, wherein the determining includes automatically determining that the purchase is a qualified transaction if a merchant code from which the purchase is made matches a predetermined automatic adjudication merchant code and an amount of the purchase matches a predetermined automatic adjudication amount.

31. The program storage device of claim 27, further including:
transmitting an amount of adjustment made due to direct payment from the account, wherein a PSP processing manual payments receives the amount and updates an account balance by the amount.

32. The program storage device of claim 27, further including:
receiving an amount of adjustment in an account made as a result of a manual payment; and
updating an account balance by the amount.

33. A system for processing transactions involving an account reserved for qualified spending, comprising:
a module in response to receiving transaction data associated with a purchase for which a payment is to be made from an account reserved for qualified spending, operable to determine whether the purchase is a qualified purchase, the module further operable to automatically determine that the purchase is a qualified transaction if a merchant code from which the purchase is made matches a predetermined automatic adjudication merchant code and an amount of the purchase matches a predetermined automatic adjudication amount, and if it is determined that the purchase is not a qualified purchase, the module being operable to request a refund for the payment made from the account.

34. The system of claim 33, wherein the module is further operable to connect to a website for allowing a user to make a refund payment.

35. The system of claim 33, wherein the module maintains a pre-tax account and a post-tax account from where payments for the purchase can be made.

36. The system of claim 33, wherein the module is further operable to automatically determine that the purchase is a qualified transaction if a merchant code from which the purchase is made matches a predetermined automatic adjudication merchant code and an amount of the purchase matches a predetermined automatic adjudication amount.

37. A method of processing transactions involving an account reserved for qualified spending, comprising:
automatically receiving transaction data associated with a purchase to be paid from an account reserved for qualified spending;
providing a post-tax account from which an amount of money for the purchase may be deducted if the account does not have a sufficient amount for the purchase;
determining whether the purchase is a qualified transaction for which payment can be made from the account; and
requesting a refund if it is determined that the purchase is not a qualified transaction.
